(19) United States
(12) Patent Application Publication
(10) Pub. No.: US 2024/0073143 A1
(43) Pub. Date: Feb. 29, 2024

(54) IN-NETWORK COMPUTATION AND CONTROL OF NETWORK CONGESTION BASED ON IN-NETWORK COMPUTATION DELAYS

(71) Applicant: Intel Corporation, Santa Clara, CA (US)

(72) Inventors: Vesh Raj Sharma Banjade, Portland, OR (US); S M Iftekharul Alam, Hillsboro, OR (US); Satish Chandra Jha, Portland, OR (US); Arvind Merwaday, Beaverton, OR (US); Kuilin Clark Chen, Portland, OR (US)

(21) Appl. No.: 18/498,940

(22) Filed: Oct. 31, 2023

(51) Int. Cl. H04L 47/12; H04L 47/283

(52) U.S. Cl. CPC H04L 47/12; H04L 47/283

(57) ABSTRACT

Systems, apparatus, articles of manufacture, and methods are disclosed for in-network computation and control of network congestion based on in-network computation delays. An example device includes interface circuitry to access a packet including a header having (1) a destination address field to identify a first network address of a destination device capable of performing an action and (2) a workload class field to identify a workload class associated with the action. The example device also includes programmable circuitry to utilize machine-readable instructions to perform the action at the device based on the workload class field, the device having a second network address that is different than the first network address. Additionally, the example programmable circuitry is to modify an indicator field of the packet to indicate that the action has been performed and cause the interface circuitry to forward the packet with the modified indicator field toward the destination device.

### FIELD OF THE DISCLOSURE

This disclosure relates generally to congestion control and, more particularly, to in-network computation and control of network congestion based on in-network computation delays.

### BACKGROUND

Edge environments (e.g., an Edge, Fog, multi-access edge computing (MEC), or Internet of Things (IoT) network) enable workload execution (e.g., execution of one or more computing tasks, execution of a machine learning model using input data, etc.) near endpoint devices that request an execution of the workload. Edge environments may include infrastructure, such as an edge platform, that is connected to cloud infrastructure, endpoint devices, and/or additional edge infrastructure via networks such as the Internet. Edge platforms may be closer in proximity to endpoint devices than cloud infrastructure, such as centralized servers.

### BRIEF DESCRIPTION OF THE DRAWINGS

FIG. 1 is a block diagram of an example multi-tier network including an example edge layer, an example aggregation layer, and an example core layer.

FIG. 2 is a block diagram of an example implementation of an example application layer-capable device of the multi-tier network of FIG. 1.

FIG. 3 is a block diagram of an example implementation of an example feedback-capable device of the multi-tier network of FIG. 1.

FIG. 4A is an illustration of an example packet including an example header in accordance with examples disclosed herein.

FIG. 4B is another illustration of an example packet including an example header in accordance with examples disclosed herein.

FIG. 5 illustrates an overview of an Edge cloud configuration for Edge computing.

FIG. 6 illustrates operational layers among endpoints, an Edge cloud, and cloud computing environments.

FIG. 7 illustrates an example approach for networking and services in an Edge computing system.

FIG. 8 is a flowchart representative of example machine-readable instructions and/or example operations that may be executed, instantiated, and/or performed by example programmable circuitry to implement the application layer-capable device of FIG. 2 to control network congestion based on in-network computation delay.

FIG. 9 is a flowchart representative of example machine-readable instructions and/or example operations that may be executed, instantiated, and/or performed by example programmable circuitry to implement the feedback-capable device of FIG. 3 to perform in-network processing.

FIG. 10 is a flowchart representative of example machine-readable instructions and/or example operations that may be executed, instantiated, and/or performed by example programmable circuitry to implement the feedback-capable device of FIG. 3 to compute a bitrate to be utilized to transmit a packet flow based on in-network computation delay.

FIG. 11 is a flowchart representative of example machine-readable instructions and/or example operations that may be executed, instantiated, and/or performed by example programmable circuitry to implement the feedback-capable device of FIG. 3 to compute control parameters of the feedback-capable device based on in-network computation delay.

FIG. 12 is a flowchart representative of example machine-readable instructions and/or example operations that may be executed, instantiated, and/or performed by example programmable circuitry to implement the application layer-capable device of FIG. 2 to process a congestion notification packet.

FIG. 13 is a flowchart representative of example machine-readable instructions and/or example operations that may be executed, instantiated, and/or performed by example programmable circuitry to implement the application layer-capable device of FIG. 2 to perform bitrate recover after network congestion has subsided.

FIG. 14 is a block diagram of an example processing platform including programmable circuitry structured to execute, instantiate, and/or perform the example machine-readable instructions and/or perform the example operations of FIGS. 8, 9, 10, 11, 12, and/or 13 to implement the application layer-capable device of FIG. 2 and/or the feedback-capable device of FIG. 3.

FIG. 15 is a block diagram of an example implementation of the programmable circuitry of FIG. 14.

FIG. 16 is a block diagram of another example implementation of the programmable circuitry of FIG. 14.

FIG. 17 is a block diagram of an example software/firmware/instructions distribution platform (e.g., one or more servers) to distribute software, instructions, and/or firmware (e.g., corresponding to the example machine-readable instructions of FIGS. 8, 9, 10, 11, 12, and/or 13) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Edge environments and/or cloud environments may include in-network computing (INC) capable devices. In some examples, characteristics of an INC capable device include (i) performing line-rate processing with minimal latency, (ii) balancing network bandwidth with available computation on a per packet basis, and (iii) ensuring that quality of service (QoS) and/or other parameters of service level agreements (SLAs) are satisfied despite limited compute, storage, and/or memory capabilities of the INC capable device. In some examples, an INC capable device has additional or alternative characteristics. As used herein, line rate refers to a data transmission rate with which one or more bits are sent onto a transmission medium, such as a wire, a wireless communication channel, a wired network, etc.

INC capable devices (sometimes referred to as INC capable network nodes) include switches (e.g., programmable switches), switch chips, multiple switch system on a chip (SoC), routers, router chips, router SoCs, infrastructure processing units (IPUs), data processing units (DPUs), edge processing units (EPUs), and network-attached accelerator circuitry (e.g., FPGAs, ASICs, GPUs, XPUs, etc.). For example, network-attached accelerator circuitry may be implemented by a network device (e.g., a network link, network a switch, etc.) including accelerator circuitry (e.g., FPGA-based accelerator circuitry) to accelerate demanding workloads such as distributed machine learning. Further examples of network-attached accelerator circuitry include off-the-shelf network devices that are altered to include accelerator circuitry. Additionally, an INC capable device may be a programmable network device (e.g., a programmable network switch) that offers reliable network transport with flexible congestion control to meet stringent latency requirements imposed by workloads running at the edge and/or in the cloud. Example programmable switches may be programmed with one or more programming languages such as the P4 programming language, the software for open network in the cloud (SONiC) programming language, the network programming language (NPL), among others.

In some examples, to achieve example characteristics of an INC capable device, a device can (i) offload as well as reuse primitive operations (e.g., a vector summation operation, a count operation, a cache operation, a store operation, a get operations, a hash table operation, etc.), (ii) be robust to failure (e.g., packet loss, link failure, etc.), and/or (iii) trade-off between (a) retaining and/or sharing an amount of network traffic for workload scalability and (b) providing support for retaining compatibility across legacy networking functionalities and policies. In some examples, to achieve characteristics of an INC capable device, a device can perform additional or alternative operations. The transport layer of the Open Systems Interconnection (OSI) model and the ability to deal with network congestion and flow control (CFC) within the transport layer can be utilized to realize INC capable devices.

Examples disclosed herein include INC-aware CFC throughout a network fabric (e.g., at an end-host device in a network as well as other devices in the network other than the end host). Disclosed example methods, apparatus, and articles of manufacture include transport layer CFC techniques to render a network (e.g., an Edge network, a Cloud network, etc.) lossless, efficient, and scalable by performing CFC tasks through the network fabric and end-host devices in a joint manner. As used herein, an end-host device refers to a device that originates a packet flow in a network (e.g., a source computer) or terminates a packet flow in a network (e.g., a destination computer). As used herein, a packet flow refers to a sequence of packets transmitted from an end-host device to a destination, which may be another end-host device, a multicast group of devices, or a broadcast domain.

Additionally or alternatively, a packet flow refers to a sequence of packets sent from a particular end-host device to a particular unicast, anycast, or multicast destination that the end-host device labels as a packet flow. In some examples, a packet flow can consist of all packets in a specific transport connection or a media stream. However, a packet flow may not map one-to-one to a transport connection (e.g., a transport connection may include a first number of packets greater than a second number of packets of the packet flow transmitted via the transport connection). In yet other examples, a packet flow refers to a set of Internet protocol (IP) packets passing an observation point in a network during a certain time interval.

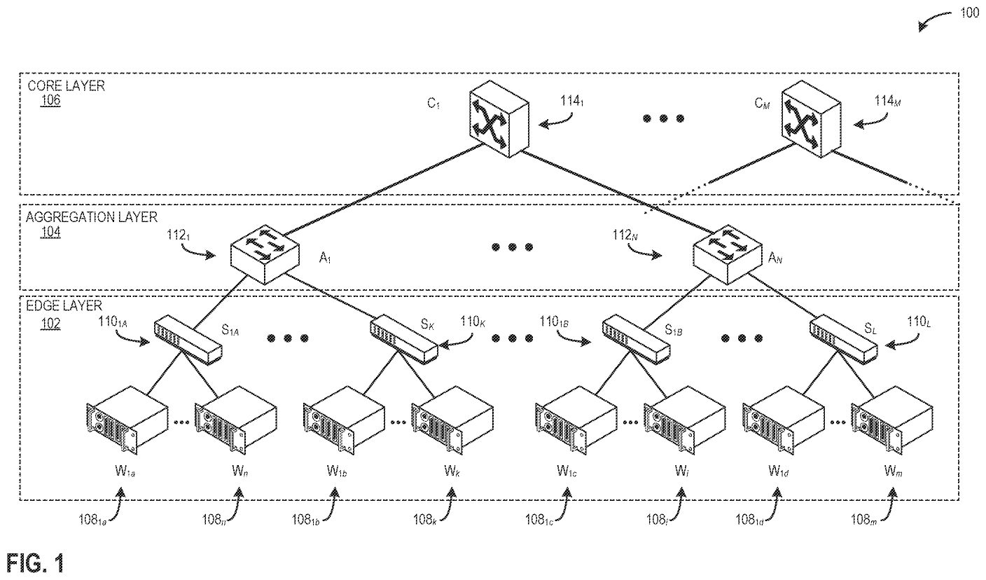

FIG. 1 is a block diagram of an example multi-tier network 100 including an example edge layer 102, an example aggregation layer 104, and an example core layer 106. In the example of FIG. 1, the multi-tier network 100 is an edge network. In additional or alternative examples, the multi-tier network 100 may be a cloud network. In the example of FIG. 1, the edge layer 102 includes devices that are located closer to an endpoint (e.g., a consumer device, a producer device, etc.) device (e.g., an autonomous vehicle, user equipment, business and industrial equipment, a video capture device, a drone, a smart city and/or building device, a sensor, an IoT device, etc.) than the aggregation layer 104 and the core layer 106.

In the example of FIG. 1, compute, memory, and storage resources that are offered at the edge layer 102 are beneficial for providing ultra-low latency response times for services and functions used by endpoint data sources as well as reducing network backhaul traffic from the edge layer 102 toward the core layer 106 thus improving energy consumption and overall network usages among other benefits. In the multi-tier network 100 of FIG. 1, compute, memory, and storage can be scarce resources, and generally decrease depending on location (e.g., fewer processing resources being available at consumer endpoint devices, than at devices in the edge layer 102, than at devices in the core layer 106). However, the closer that a location is to an endpoint (e.g., user equipment (UE)), the more that space and power may be constrained.

In the illustrated example of FIG. 1, the edge layer 102 includes example edge compute devices 108 and example edge network devices 110. For example, the edge layer 102 includes first edge compute devices 108₁ₐ-108ₙ (denoted W₁ₐ-Wₙ in communication with a first edge network device 110_{1A} (denoted S_{1A}). Additionally, the edge layer 102 includes second edge compute devices 108_{1b}-108ₖ (denoted W_{1b}-Wₖ) in communication with a second edge network device 110_{K} (denoted S_{K}). In the example of FIG. 1, the edge layer 102 includes third edge compute devices 108_{1c}-108ₗ (denoted W_{1c}-Wₗ) in communication with a third edge network device 110_{1B} (denoted S_{1B}). Additionally, the edge layer 102 includes fourth edge compute devices 108_{1d}-108ₘ (denoted W_{1d}-Wₘ) in communication with a fourth edge network device 110_{L} (denoted S_{L}).

In the illustrated example of FIG. 1, one or more of the edge compute devices 108 may be implemented by a gateway, a server (e.g., an on-premises server), or network equipment located in physically proximate to one or more endpoint devices. In some examples, one or more of the edge compute devices 108 includes accelerator circuitry. In the example of FIG. 1, one or more of the edge compute devices 108 implement one or more services and/or one or more functions that can be used by endpoint data sources.

In the illustrated example of FIG. 1, one or more of the edge network devices 110 may be implemented by an FPGA with a network interface controller (sometimes referred to as network interface circuitry), an XPU, a programmable network switch, a middlebox, among others. In some examples, one or more of the edge network devices 110 includes accelerator circuitry. In the example of FIG. 1, one or more of the edge network devices 110 facilitate communications between one or more devices of the edge layer 102 and one or more devices of the aggregation layer 104.

In the illustrated example of FIG. 1, devices that are offered at the aggregation layer 104 facilitate transmission of data between the edge layer 102 and the core layer 106. For example, devices offered at the aggregation layer 104 forward network traffic from the core layer 106 to the edge layer 102. Additionally, devices offered at the aggregation layer 104 gather network traffic from the edge layer 102 and forward the network traffic to the core layer 106.

In the illustrated example of FIG. 1, the aggregation layer 104 includes example aggregation network devices 112. For example, the aggregation layer 104 includes a first aggregation network device 112₁ (denoted A₁) in communication with the first edge network device 110_{1A} and the second edge network device 110_{K}. Additionally, the aggregation layer 104 includes a second aggregation network device 112_{N} (denoted A_{N}) in communication with the third edge network device 110_{1B} and the fourth edge network device 110_{L}. In the example of FIG. 1, one or more of the aggregation network devices 112 may be implemented by a base station, a radio processing unit, a network hub, a regional data center (DC), local network equipment, among others. Additionally, one or more of the aggregation network devices 112 may include or be implemented by an FPGA with a network interface controller, an XPU, a programmable network switch, a middlebox, among others. In some examples, one or more of the aggregation network devices 112 includes accelerator circuitry.

In the illustrated example of FIG. 1, one or more of the aggregation network devices 112 bundle multiple network connections to be together into a single communication link. As such, the aggregation network devices 112 provide increased bandwidth and better network performance. In the example of FIG. 1, the aggregation network devices 112 utilize link aggregation protocols, such as Link Aggregation Control Protocol (LACP) and Ethernet Aggregation, to combine multiple communication links into a single, logical connection. As such, the aggregation network devices 112 offer flexibility and scalability, which allows for network expansion or reconfiguration. Generally, the aggregation network devices 112 include greater compute, memory, and storage resources than the edge network devices 110. Additionally, the aggregation network devices 112 provide faster switching rates (e.g., greater bandwidth) than the edge network devices 110. Furthermore, the aggregation network devices 112 include fewer interfaces than the edge network devices 110.

In the illustrated example of FIG. 1, devices that are offered at the core layer 106 facilitate transmission of data between devices in the aggregation layer 104. As such, devices offered at the core layer 106 perform a large portion of data transmission and routing in the multi-tier network 100. In the example of FIG. 1, the core layer 106 includes example core network devices 114. For example, the core layer 106 includes a first core network device 114₁ (denoted C₁) in communication with the first aggregation network device 112₁ and the second aggregation network device 112_{N}.

In the illustrated example of FIG. 1, one or more of the core network devices 114 may be implemented by a core network data center. In some examples, one or more of the core network devices 114 may include or be implemented by an FPGA with a network interface controller, an XPU, a programmable network switch, a middlebox, among others. In some examples, one or more of the core network devices 114 includes accelerator circuitry.

In the illustrated example of FIG. 1, the core network devices 114 generally include greater compute, memory, and storage resources than the aggregation network devices 112. Additionally, the core network devices 114 provide faster switching rates (e.g., greater bandwidth) than the aggregation network devices 112. Furthermore, the core network devices 114 include fewer interfaces than the aggregation network devices 112. In the example of FIG. 1, network communications within the multi-tier network 100 and among the various layers may occur via any number of wired and/or wireless mediums, including via connectivity architectures and technologies not depicted.

In the illustrated example of FIG. 1, one or more of the edge compute devices 108 may operate as an end-host (EH) device or an in-network (IN) device. Additionally, one or more of the edge network devices 110, one or more of the aggregation network devices 112, and/or one or more of the core network devices 114 may operate as an IN device or an EH device. As described above, an EH device refers to a device that originates a packet flow in a network (e.g., a source computer) or terminates a packet flow in a network (e.g., a destination computer). Additionally, an in-network device refers to a device that may lay along a network path of an end-to-end (E2E) packet flow from a source device to the destination device. In the context of an in-network device, in-network refers to a device type or classification based on characteristics and/or capabilities of the device and does not refer to a state of operation of that device (e.g., does not require the device to be included and/or inserted in a network or be in operation in a network to be considered an in-network device). Example in-network devices include switches (e.g., programmable switches), switch chips, switch SoCs, routers, router chips, router SoCs, IPUs, DPUs, EPUs, programmable accelerator circuitry (e.g., FPGAs, ASICs, GPUs, XPUs, etc.), among others. A device may operate as an IN device when the device is an intermediary device (e.g., on a communication path between a source device and a destination device) responsible for routing, switching, and/or relaying incoming packets.

In some examples, IN devices provide compute capability to process incoming packets (e.g., data associated with a workload with which the packets are associated). For example, compute circuitry of an IN device can range from a low-compute capable circuitry (e.g., an Atom® processor offered by Intel Corporation) to fully-compute capable circuitry (e.g., a Xeon® processor offered by Intel Corporation). Generally, when two IN devices are on the same network path (e.g., sharing a source device and a destination device), compute capabilities of a first IN device may be lower than compute capabilities of a second IN device that is one or more hops closer to a source device and/or a destination device on the network path. In the example of FIG. 1, EH devices generally provide greater compute capabilities than IN devices. However, in some examples, an IN device may provide greater compute capabilities than an EH device.

In the illustrated example of FIG. 1, network congestion may occur at the EH devices and/or IN devices. Advantageously, examples disclosed herein implement congestion control (CC) and flow control (FC). Disclosed methods, apparatus, and articles of manufacture implement advanced CC and FC techniques to provide INC-aware network functionalities. For example, INC-aware network functionalities can be implemented at both EH devices and IN devices (e.g., programmable IPUs, programmable DPUs, programmable EPUs, FPGA-based intermediate accelerator circuitry, etc.).

Example EH devices and/or IN devices disclosed herein utilize the transport layer of the OSI model to communicate information between devices in a communication path. For example, disclosed EH devices and/or IN devices attach contextual information to packets transmitted in the transport layer to introduce to and/or retain various information in packets that are communicated in a network. Additionally, disclosed IN devices determine the contextual information to determine how received data is to be interpreted when processed by an IN device. For example, contextual information includes information identifying queue utilization, bitrate utilized to transmit a packet flow, a traffic class, etc.

Examples disclosed herein include packet flow granularity level (e.g., packet level, message level, and byte stream level) adaptation correlation with the INC-aware application context to divide execution of the transport functionalities at both EH devices and IN devices. As such, methods, apparatus, and articles of manufacture disclosed herein improve network reliability, traffic flow, and congestion control features to improve performance of INC-aware applications. For example, disclosed methods, apparatus, and articles of manufacture jointly consider network fabric (e.g., IN device) and EH device congestion control with INC-awareness to allow a network to handle large-scale in-cast congestion at IN devices and/or EH devices.

As such, disclosed methods, apparatus, and articles of manufacture provide reliable and rapid congestion detection, signaling, and rate adaptation and allow for heterogeneous traffic classes to coexist in a network with varying flow-level requirements. Additionally, examples disclosed herein reduce tail-latency and improve fairness for coexisting packet flows as a network (e.g., an edge network, a cloud network, etc.) may run multi-tenant workloads concurrently (e.g., simultaneously, contemporaneously, etc.). Although a particular network topology is illustrated in the example of FIG. 1, disclosed methods, apparatus, and articles of manufacture are applicable to additional or alternative network topologies.

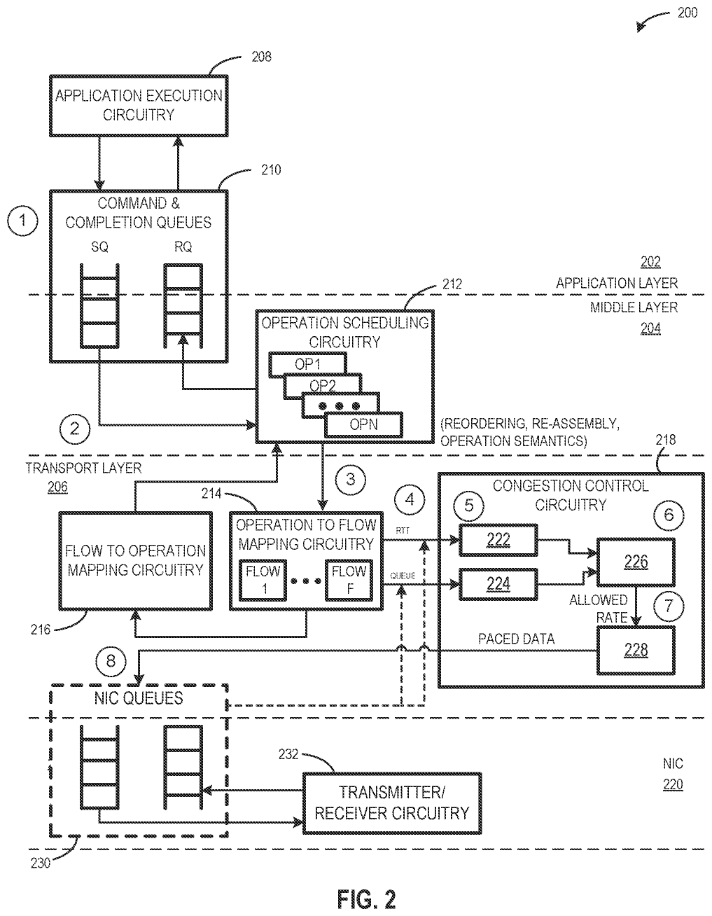

FIG. 2 is a block diagram of an example implementation of an example application layer-capable device 200 of the multi-tier network 100 of FIG. 1. In some examples, the application layer-capable device 200 implements an EH device in the multi-tier network 100 of FIG. 1. In some examples, the application layer-capable device 200 implements an IN device in the multi-tier network 100 of FIG. 1. In the example of FIG. 2, the application layer-capable device 200 operates in an example application layer 202, an example middle layer 204, and an example transport layer 206. In the example of FIG. 2, the application layer 202 corresponds to the application layer of the OSI model. Additionally, the middle layer 204 and the transport layer 206 of FIG. 2 correspond to the middle layer and transport layer of the OSI model, respectively.

In the illustrated example of FIG. 2, the application layer-capable device 200 includes example application execution circuitry 208, example command and completion queues 210, example operation scheduling circuitry 212, example operation to flow mapping circuitry 214, example flow to operation mapping circuitry 216, example congestion control circuitry 218, and example network interface controller (NIC) 220. In the example of FIG. 2, the congestion control circuitry 218 includes example delay determination circuitry 222, example queue analysis circuitry 224, example rate computation circuitry 226, and example pacing circuitry 228. In the example of FIG. 2, the NIC 220 includes example NIC queues 230 and example transmitter and/or receiver circuitry 232.

In the illustrated example of FIG. 2, the application layer-capable device 200 may be instantiated (e.g., creating an instance of, bring into being for any length of time, materialize, implement, etc.) by programmable circuitry such as a Central Processor Unit (CPU) executing first instructions. Additionally or alternatively, the application layer-capable device 200 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

In the illustrated example of FIG. 2, the application layer-capable device 200 implements application context- and/or semantics-aware joint queueing- and delay-based congestion detection and control. For example, the application execution circuitry 208 adds application context and/or semantics to one or more application layer packets generated based on a workload performed by the application execution circuitry 208. For example, to add application context and/or semantics to one or more application layer packets, the application execution circuitry 208 can set a flag in metadata of a header of the one or more application layer packets.

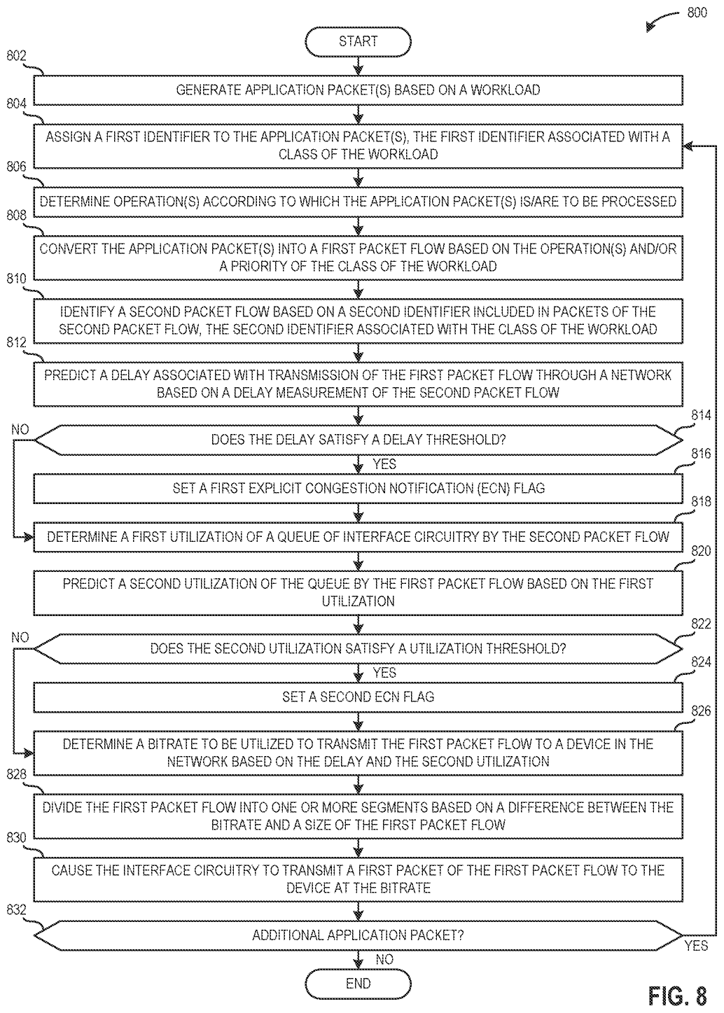

In the illustrated example of FIG. 2, the application execution circuitry 208 is coupled to the command and completion queues 210. In some examples, the application execution circuitry 208 is instantiated by programmable circuitry executing application instructions and/or configured to perform operations such as those represented by the flowchart of FIG. 8. In example operation of the application layer-capable device 200, the application execution circuitry 208 performs a workload associated with an application. For example, the application executed by the application execution circuitry 208 initiates and/or triggers a bitstream (e.g., byte stream) and the application execution circuitry 208 starts filling a sending queue (SQ) of the command and completion queues 210 with the bitstream. In the example of FIG. 2, to perform an operation in a network (e.g., the multi-tier network 100 of FIG. 1), the application executed by the application execution circuitry 208 writes a command (in the form of one or more application layer packets) to the SQ of the command and completion queues 210. In the example of FIG. 2, the command and completion queues 210 include the SQ and a receiving queue (RQ).

In some examples, based on the type and/or class of application and/or workload, the application execution circuitry 208 assigns a class identifier (ID), workload ID, and/or application ID to the one or more application layer packets. As such, when the one or more application layer packets (sometimes referred to as application packets) are accessed by the operation scheduling circuitry 212, the ID (e.g., class ID, workload ID, and/or application ID) is retained to be accessed by circuitry operating in the middle layer 204 and can be passed onto lower layers of the OSI model (e.g., the transport layer 206) and/or communicated between devices in the multi-tier network 100. For example, by adding a class ID, workload ID, and/or application ID to the one or more application layer packets, the application execution circuitry 208 can request that an IN device process data associated with the workload and/or the application corresponding to the ID (e.g., a request to process data associated with the workload corresponding to the workload type).

In this manner, assigning a class ID, workload ID, and/or application ID to the one or more application layer packets serves as setting a flag in metadata of a header of a packet as described above. Thus, by including (e.g., inserting) an ID in a packet, the application execution circuitry 208 facilitates an IN device (e.g., an in-network switch) that receives the packet determining whether to process the packet locally. For example, the IN device can perform application-layer processing on packets of a packet flow if the IN device includes processing capacity to perform such processing. For example, an IN device processes first payload data of a payload included with a packet to generate second payload data. In at least some such examples, the IN device updates the payload of the packet based on the second payload data to generate an updated payload. For example, the IN device may replace the first payload data of the packet with the second payload data. In some examples, the IN device appends the second payload data to the first payload data. In some examples, the IN device adjusts the first payload data based on the second payload data.

In the illustrated example of FIG. 2, the application execution circuitry 208 creates an ID (e.g., the class ID, workload ID, and/or application ID) based on a type and/or a class of application and/or workload originating a flow of application layer packets. For example, the application execution circuitry 208 creates an ID to uniquely associate one or more application layer packets with the type and/or class of application and/or workload. As such, an ID can be retained with the one or more application layer packets as the one or more application layer packets are processed by a network. Thus, example IDs disclosed herein retain application context- and/or semantics-awareness throughout lower layers of the OSI model (e.g., the middle layer 204, the transport layer 206, etc.) and/or between devices in the multi-tier network 100.

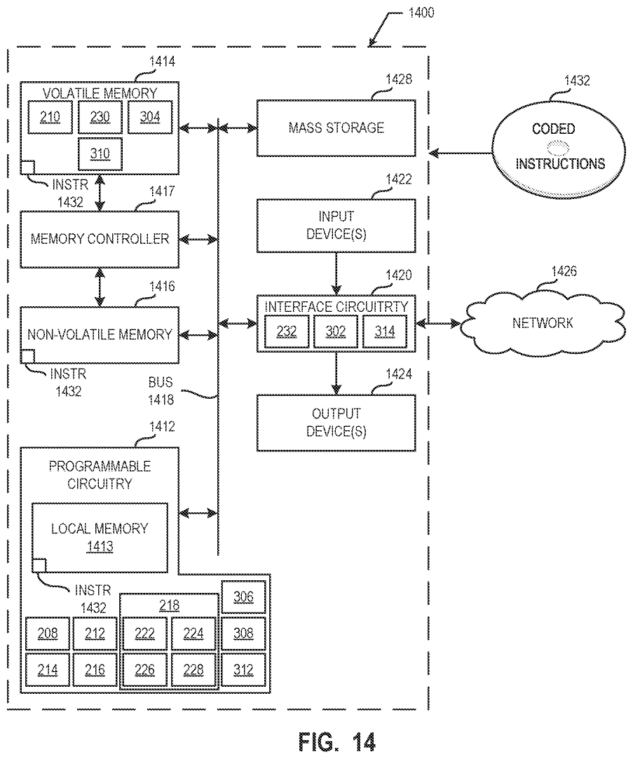

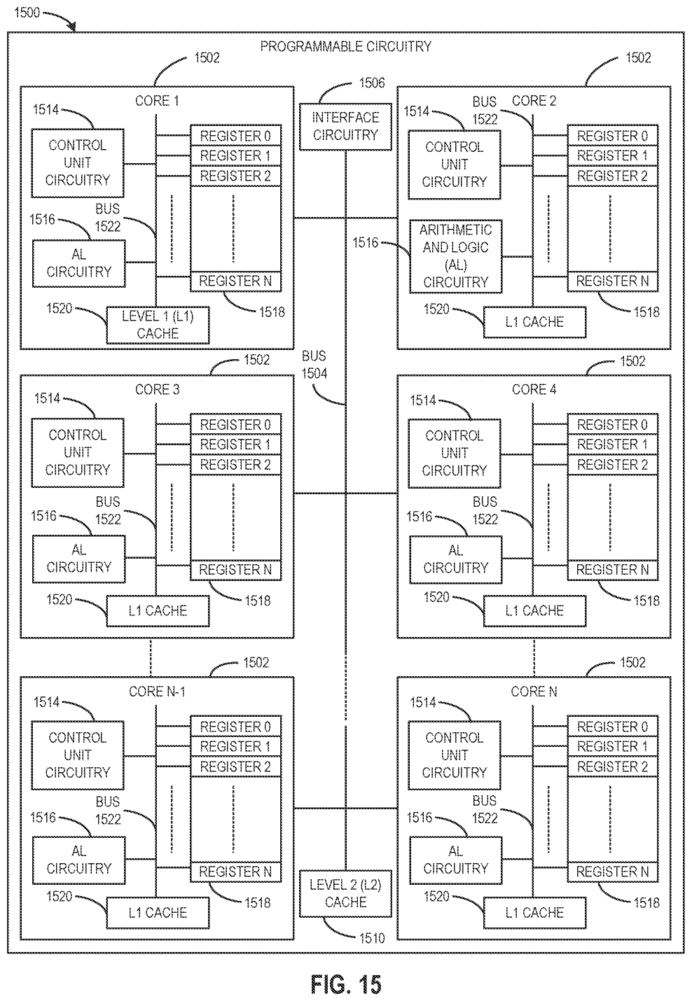

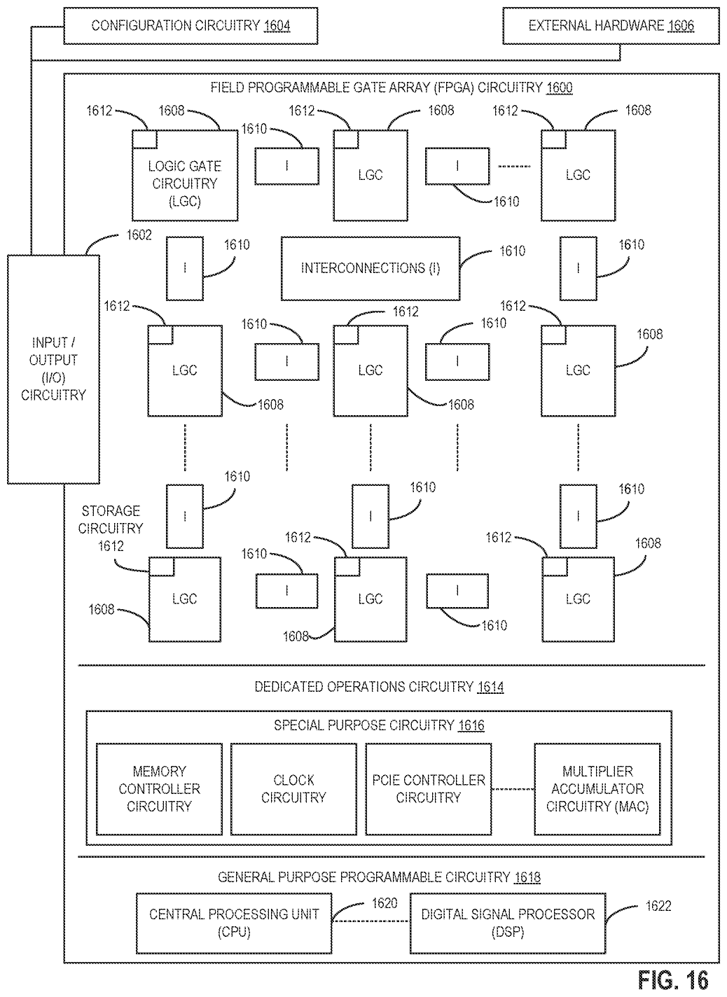

In some examples, the application layer-capable device 200 includes means for generating one or more application packets. For example, the means for generating one or more application packets may be implemented by the application execution circuitry 208. In some examples, the application execution circuitry 208 may be instantiated by programmable circuitry such as the example programmable circuitry 1412 of FIG. 14. For instance, the application execution circuitry 208 may be instantiated by the example microprocessor 1500 of FIG. 15 executing machine-executable instructions such as those implemented by at least blocks 802, 804, and 832 of FIG. 8. In some examples, the application execution circuitry 208 may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the application execution circuitry 208 may be instantiated by any other combination of hardware, software, and/or firmware. For example, the application execution circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 2, the command and completion queues 210 are coupled to the application execution circuitry 208 and the operation scheduling circuitry 212. In the example of FIG. 2, the application layer-capable device 200 includes the command and completion queues 210 to record data (e.g., one or more application layer packets, etc.) to be transmitted through the multi-tier network 100 and/or to be processed by the application execution circuitry 208 before being transmitted through the multi-tier network 100. The command and completion queues 210 may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The command and completion queues 210 may additionally or alternatively be implemented by one or more double data rate (DDR) memories, such as DDR, DDR2, DDR3, DDR4, DDR5, mobile DDR (mDDR), DDR SDRAM, etc. The command and completion queues 210 may additionally or alternatively be implemented by one or more mass storage devices such as hard disk drive(s) (HDD(s)), compact disk (CD) drive(s), digital versatile disk (DVD) drive(s), solid-state disk (SSD) drive(s), Secure Digital (SD) card(s), CompactFlash (CF) card(s), etc. While in the illustrated example the command and completion queues 210 are illustrated as two queues, the command and completion queues 210 may be implemented by any number and/or type(s) of queues. Furthermore, the data stored in the command and completion queues 210 may be in any data format such as, for example, binary data, comma delimited data, tab delimited data, structured query language (SQL) structures, etc.

In the illustrated example of FIG. 2, the operation scheduling circuitry 212 is coupled to the command and completion queues 210, the operation to flow mapping circuitry 214, and the flow to operation mapping circuitry 216. In some examples, the operation scheduling circuitry 212 is instantiated by programmable circuitry executing operation scheduling instructions and/or configured to perform operations such as those represented by the flowchart of FIG. 8. In example operation of the application layer-capable device 200, the operation scheduling circuitry 212 accesses one or more application layer packets from the command and completion queues 210 and schedules the one or more application layer packets. For example, the operation scheduling circuitry 212 determines one or more operations according to which the one or more application layer packets are to be processed.

In the illustrated example of FIG. 2, example operations include packet re-ordering, packet re-assembly, packet duplication, among others. In the example of FIG. 2, the one or more operations scheduled by the operation scheduling circuitry 212 are scheduled to improve robustness and/or reliability of one or more packets passed on to the transport layer 206. As described above, the application context- and/or semantics-awareness is retained in the one or more application layer packets via an ID identified in header metadata of the one or more application layer packets.

In some examples, the application layer-capable device 200 includes means for determining one or more operations. For example, the means for determining one or more operations may be implemented by the operation scheduling circuitry 212. In some examples, the operation scheduling circuitry 212 may be instantiated by programmable circuitry such as the example programmable circuitry 1412 of FIG. 14. For instance, the operation scheduling circuitry 212 may be instantiated by the example microprocessor 1500 of FIG. 15 executing machine-executable instructions such as those implemented by at least block 806 of FIG. 8. In some examples, the operation scheduling circuitry 212 may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the operation scheduling circuitry 212 may be instantiated by any other combination of hardware, software, and/or firmware. For example, the operation scheduling circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 2, the operation to flow mapping circuitry 214 is coupled to the operation scheduling circuitry 212, the flow to operation mapping circuitry 216, the delay determination circuitry 222, and the queue analysis circuitry 224. In some examples, the operation to flow mapping circuitry 214 is instantiated by programmable circuitry executing operation mapping instructions and/or configured to perform operations such as those represented by the flowchart of FIG. 8. In example operation of the application layer-capable device 200, the operation to flow mapping circuitry 214 converts the one or more application layer packets into a packet flow based on the one or more operations.

In the illustrated example of FIG. 2, to convert the one or more application layer packets into a packet flow, the flow mapping circuitry 214 maps the one or more operations to a transport layer packet flow (e.g., packet stream). In some examples, the operation to flow mapping circuitry 214 also converts the one or more application layer packets into a packet flow based on a priority of a class of a workload with which the one or more application packets are associated. For example, the operation to flow mapping circuitry 214 parses and/or decodes the control plane of application layer packets to expose the contents of the application layer packets and identify a priority of associated commands. As such, the operation to flow mapping circuitry 214 can classify and prioritize packet flows based on context and/or urgency to better handle network congestion by utilizing application context- and/or semantic-aware IDs included in application layer packets. In the example of FIG. 2, the application layer-capable device 200 also includes the flow to operation mapping circuitry 216 which is to convert transport layer packet flows into one or more application layer packets.

In some examples, the application layer-capable device 200 includes means for converting one or more application packets. For example, the means for converting one or more application packets may be implemented by the operation to flow mapping circuitry 214. In some examples, the operation to flow mapping circuitry 214 may be instantiated by programmable circuitry such as the example programmable circuitry 1412 of FIG. 14. For instance, the operation to flow mapping circuitry 214 may be instantiated by the example microprocessor 1500 of FIG. 15 executing machine-executable instructions such as those implemented by at least block 808 of FIG. 8. In some examples, the operation to flow mapping circuitry 214 may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the operation to flow mapping circuitry 214 may be instantiated by any other combination of hardware, software, and/or firmware. For example, the operation to flow mapping circuitry 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 2, the congestion control circuitry 218 is coupled to the operation to flow mapping circuitry 214 and the NIC queues 230. In some examples, the congestion control circuitry 218 is instantiated by programmable circuitry executing congestion control instructions and/or configured to perform operations such as those represented by the flowcharts of FIGS. 8, 12, and 13. In example operation of the application layer-capable device 200, the congestion control circuitry 218 implements joint queuing- and delay-based congestion detection and control. As described above, the application layer-capable device 200 may implement an EH device and/or an IN device. As such, the application layer-capable device 200 facilitates joint queuing- and delay-based congestion detection and control at both EH devices and IN devices and decouples network fabric and EH congestion.

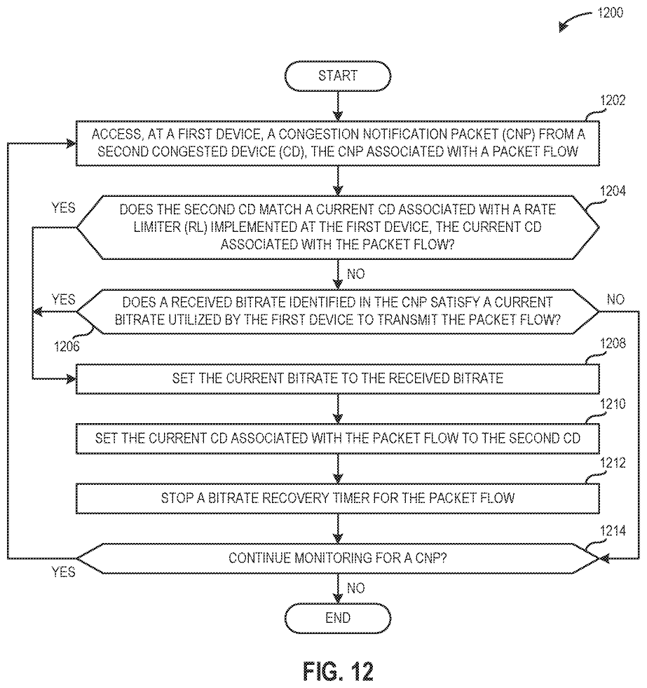

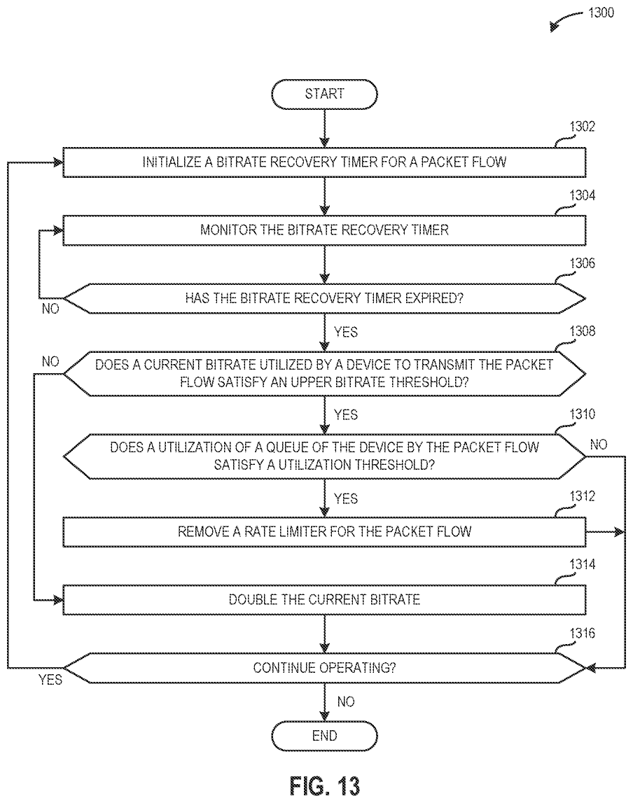

In some examples, the application layer-capable device 200 includes means for controlling congestion. For example, the means for controlling congestion may be implemented by the congestion control circuitry 218. In some examples, the congestion control circuitry 218 may be instantiated by programmable circuitry such as the example programmable circuitry 1412 of FIG. 14. For instance, the congestion control circuitry 218 may be instantiated by the example microprocessor 1500 of FIG. 15 executing machine-executable instructions such as those implemented by at least blocks 810, 812, 814, 816, 818, 820, 822, 824, 826, 828, and 830 of FIG. 8, at least blocks 1202, 1204, 1206, 1208, 1210, 1212, and 1214 of FIG. 12, and/or at least blocks 1302, 1304, 1306, 1308, 1310, 1312, 1314, and 1316 of FIG. 13. In some examples, the congestion control circuitry 218 may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the congestion control circuitry 218 may be instantiated by any other combination of hardware, software, and/or firmware. For example, the congestion control circuitry 218 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

As described above, the congestion control circuitry 218 includes the delay determination circuitry 222, the queue analysis circuitry 224, the rate computation circuitry 226, and the pacing circuitry 228. In the example of FIG. 2, the delay determination circuitry 222 is coupled to the operation to flow mapping circuitry 214, the rate computation circuitry 226, and the NIC queues 230. In some examples, the delay determination circuitry 222 is instantiated by programmable circuitry executing delay determination instructions and/or configured to perform operations such as those represented by the flowchart of FIG. 8.

In example operation of the application layer-capable device 200, the delay determination circuitry 222 identifies one or more historical packet flows having second IDs matching a first ID of a packet flow being processed by the delay determination circuitry 222. Based on identifying a historical packet flow having a matching ID to the current packet flow, the delay determination circuitry 222 determines a delay measurement of the second packet flow. For example, the delay determination circuitry 222 determines a round-trip time (RTT) of the second packet flow.

In the illustrated example of FIG. 2, the RTT of a historical packet flow may be acquired via techniques such as in-network telemetry (INT). In the example of FIG. 2, INT allows the congestion control circuitry 218 to infer network states and/or collect metadata from the network over single and/or multi-hops. For example, timestamps (TSs) of packets during dequeuing, queue length (QLen) measurements at the time a packet is dequeued, transmission sizes (TxBytes) measurements (in bytes), and speed class of egress ports at an IN device can aid the congestion control circuitry 218 with dynamic scaling of target delay based on network load and/or network topology. Additionally, telemetry data collected at an EH device can be fed back to a packet flow originator to signal when the EH packet processing stack has limited resources (which adds latency to packet flow completion time). As such, the packet flow originator can adjust the packet flow (e.g., temporarily stop the packet flow, reduce the bitrate of the packet flow, etc.).

In the illustrated example of FIG. 2, the delay measurement may be determined as an E2E measurement (e.g., the time for a packet (or a packet flow) to travel from a source device to a destination device and for the source device to receive an acknowledgement from the destination device). Additionally or alternatively, the delay measurement may be determined as a single-hop measurement (e.g., the time for a packet (or packet flow) to travel from a first device in a communication path to a next device in the communication path and for the first device to receive an acknowledgement from the next device). In some examples, the delay measurement may be determined as a hop-by-hop measurement (e.g., the sum of single-hop delay measurements measured at each IN device along an E2E path).

In example operation of the application layer-capable device 200, the delay determination circuitry 222 predicts a delay associated with transmission of the current packet flow through the network based on the delay measurement of a historical packet flow. Additionally, the delay determination circuitry 222 determines whether the predicted delay satisfies (e.g., is greater than) a delay threshold for the application layer-capable device 200. In some examples, when the application layer-capable device 200 implements an EH device, the delay threshold is determined based on a maximum allowable E2E delay such that the EH device delay does not cause the E2E delay to exceed a maximum allowable E2E delay for a communication path including the EH device. Additionally or alternatively, when the application layer-capable device 200 implements an IN device, the delay threshold is determined based on a maximum allowable delay at the IN device such that the IN device delay does not cause the E2E delay to exceed a maximum allowable E2E delay for a communication path including the IN device. Based on the delay determination circuitry 222 determining that the predicted delay satisfies the delay threshold, the delay determination circuitry 222 sets a first explicit congestion notification (ECN) flag for packets of the current packet flow. For example, the delay determination circuitry 222 sets one or more bits in headers of packets of the current packet flow.

In some examples, the application layer-capable device 200 includes means for predicting a delay. For example, the means for predicting a delay may be implemented by the delay determination circuitry 222. In some examples, the delay determination circuitry 222 may be instantiated by programmable circuitry such as the example programmable circuitry 1412 of FIG. 14. For instance, the delay determination circuitry 222 may be instantiated by the example microprocessor 1500 of FIG. 15 executing machine-executable instructions such as those implemented by at least blocks 810, 812, 814, and 816 of FIG. 8. In some examples, the delay determination circuitry 222 may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the delay determination circuitry 222 may be instantiated by any other combination of hardware, software, and/or firmware. For example, the delay determination circuitry 222 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 2, the queue analysis circuitry 224 is coupled to the operation to flow mapping circuitry 214, the rate computation circuitry 226, and the NIC queues 230. In some examples, the queue analysis circuitry 224 is instantiated by programmable circuitry executing queue analysis instructions and/or configured to perform operations such as those represented by the flowchart of FIG. 8. In example operation of the application layer-capable device 200, the queue analysis circuitry 224 determines state information of a queue (e.g., an SQ) of the NIC queues 230.

In the illustrated example of FIG. 2, the queue state information may be the queue state information for the current packet flow. Additionally or alternatively, the queue state information may be queue state information for a historical packet flow. For example, the queue analysis circuitry 224 receives an identification of the one or more historical packet flows having matching IDs from the delay determination circuitry 222. In some examples, the queue analysis circuitry 224 identifies one or more historical packet flows having second IDs matching a first ID of a packet flow being processed by the queue analysis circuitry 224 and forwards an identification of the one or more historical packet flows to the delay determination circuitry 222.

In the illustrated example of FIG. 2, queue state information corresponds to a utilization of the queue. Example queue utilization may be determined as an E2E measurement (e.g., the utilization of the queue by a packet (or a packet flow) to be transmitted from a source device to a destination device). Additionally or alternatively, queue utilization may be determined as a single-hop measurement (e.g., the utilization of the queue by a packet (or packet flow) to be transmitted from a first device in a communication path to a next device in the communication path). In some examples, queue utilization may be determined as a hop-by-hop measurement (e.g., the sum of single-hop queue utilization measurements measured at each IN device along an E2E path).

In example operation of the application layer-capable device 200, the queue analysis circuitry 224 predicts a second utilization of the queue by the current packet flow based on the utilization of the queue by a historical packet flow. Additionally, the queue analysis circuitry 224 determines whether the predicted utilization satisfies (e.g., is greater than) a utilization threshold for the application layer-capable device 200. In the example of FIG. 2, the utilization threshold is configurable and depends on the memory and processing latency parameters of an EH device (or an IN device if the application layer-capable device 200 implements the IN device). Based on the queue analysis circuitry 224 determining that the predicted utilization satisfies the utilization threshold, the queue analysis circuitry 224 sets a second ECN flag for packets of the current packet flow. For example, the queue analysis circuitry 224 sets one or more bits in headers of packets of the current packet flow.

In some examples, the application layer-capable device 200 includes means for predicting a utilization of a queue. For example, the means for predicting a utilization of a queue may be implemented by the queue analysis circuitry 224. In some examples, the queue analysis circuitry 224 may be instantiated by programmable circuitry such as the example programmable circuitry 1412 of FIG. 14. For instance, the queue analysis circuitry 224 may be instantiated by the example microprocessor 1500 of FIG. 15 executing machine-executable instructions such as those implemented by at least blocks 818, 820, 822, and 824 of FIG. 8. In some examples, the queue analysis circuitry 224 may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the queue analysis circuitry 224 may be instantiated by any other combination of hardware, software, and/or firmware. For example, the queue analysis circuitry 224 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 2, the rate computation circuitry 226 is coupled to the delay determination circuitry 222, the queue analysis circuitry 224, and the pacing circuitry 228. In some examples, the rate computation circuitry 226 is instantiated by programmable circuitry executing rate computing instructions and/or configured to perform operations such as those represented by the flowcharts of FIGS. 8, 12, and 13. In an example operation of the application layer-capable device 200, the rate computation circuitry 226 determines a bitrate to be utilized to transmit the current packet flow to a device in the network. For example, the rate computation circuitry 226 determines the bitrate based on the predicted delay for the current packet flow and the predicted utilization by the current packet flow. In some examples, the rate computation circuitry 226 determines the bitrate based on whether the first and/or second ECN flags are set.

In the illustrated example of FIG. 2, the bitrate determined by the rate computation circuitry 226 refers to the allowed bitrate for the packet flow based on the predicted fabric congestion (e.g., predicted queue utilization) and EH device congestion (e.g., predicted delay). As described above, by parsing and/or decoding the control plane to extract flow ID and/or other metadata at the congestion control circuitry 218, the congestion control circuitry 218 can match the current packet flow with historical packet flows to infer states (e.g., delay, queue utilization, etc.) impacting network congestion during the historical packet flows and adjust transmit parameters (e.g., bitrate) of the current packet flow accordingly.

In some examples, the application layer-capable device 200 includes means for computing a bitrate. For example, the means for computing a bitrate may be implemented by the rate computation circuitry 226. In some examples, the rate computation circuitry 226 may be instantiated by programmable circuitry such as the example programmable circuitry 1412 of FIG. 14. For instance, the rate computation circuitry 226 may be instantiated by the example microprocessor 1500 of FIG. 15 executing machine-executable instructions such as those implemented by at least block 826 of FIG. 8, at least blocks 1202, 1204, 1206, 1208, 1210, 1212, and 1214 of FIG. 12, and/or at least blocks 1302, 1304, 1306, 1308, 1310, 1312, 1314, and 1316 of FIG. 13. In some examples, the rate computation circuitry 226 may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the rate computation circuitry 226 may be instantiated by any other combination of hardware, software, and/or firmware. For example, the rate computation circuitry 226 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 2, the pacing circuitry 228 is coupled to the rate computation circuitry 226 and the NIC queues 230. In some examples, the pacing circuitry 228 is instantiated by programmable circuitry executing pacing instructions and/or configured to perform operations such as those represented by the flowchart of FIG. 8. In example operation of the application layer-capable device 200, the pacing circuitry 228 determines whether the allowed bitrate determined for the current packet flow exceeds a size of the packet flow (e.g., a first packet of the packet flow). Based on the pacing circuitry 228 determining that the size of the packet flow exceeds the allowed bitrate, the pacing circuitry 228 segments the packet flow into two or more segments.

As such, the pacing circuitry 228 may pace (e.g., slow down) a packet flow proportionally to the size of the packet flow. As described above, the header of packets of the packet flow identifies the one or more ECN flags, queue state information, and/or other metadata related to the parameters of the packet flow. Subsequently, the pacing circuitry 228 loads the one or more segments of the packet flow into a queue (e.g., an SQ) of the NIC queues 230.

In some examples, the application layer-capable device 200 includes means for dividing a packet flow. For example, the means for dividing a packet flow may be implemented by the pacing circuitry 228. In some examples, the pacing circuitry 228 may be instantiated by programmable circuitry such as the example programmable circuitry 1412 of FIG. 14. For instance, the pacing circuitry 228 may be instantiated by the example microprocessor 1500 of FIG. 15 executing machine-executable instructions such as those implemented by at least blocks 828 and 830 of FIG. 8. In some examples, the pacing circuitry 228 may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the pacing circuitry 228 may be instantiated by any other combination of hardware, software, and/or firmware. For example, the pacing circuitry 228 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 2, the NIC queues 230 are coupled to the delay determination circuitry 222, the queue analysis circuitry 224, and the pacing circuitry 228. In the example of FIG. 2, the application layer-capable device 200 includes the NIC queues 230 to record data (e.g., one or more transport layer packets, one or more packet flows, etc.) to be transmitted through the multi-tier network 100 and/or received from the multi-tier network 100. The NIC queues 230 may be implemented by a volatile memory (e.g., a SDRAM, DRAM, RDRAM, etc.) and/or a non-volatile memory (e.g., flash memory). The NIC queues 230 may additionally or alternatively be implemented by one or more DDR memories, such as DDR, DDR2, DDR3, DDR4, DDR5, mDDR, DDR SDRAM, etc. The NIC queues 230 may additionally or alternatively be implemented by one or more mass storage devices such as HDD(s), CD drive(s), DVD drive(s), SSD drive(s), SD card(s), CF card(s), etc. While in the illustrated example the NIC queues 230 are illustrated as two queues, the NIC queues 230 may be implemented by any number and/or type(s) of queues. Furthermore, the data stored in the NIC queues 230 may be in any data format such as, for example, binary data, comma delimited data, tab delimited data, SQL structures, etc.

In the illustrated example of FIG. 2, the transmitter and/or receiver circuitry 232 is coupled to the NIC queues 230. In example operation of the application layer-capable device 200, the transmitter and/or receiver circuitry 232 transmits a first segment (e.g., a first packet) of the packet flow at the bitrate. As described above, the updated headers of packets of the packet flow maintain application context- and/or semantics-awareness from the application layer 202 through the NIC 220 (operating in the physical layer of the OSI model). As such, application context- and/or semantics-awareness is communicated to a destination device via the updated header of packets of the packet flow. In examples disclosed herein, a destination device may be one hop away or multiple hops away from a source device.

In the illustrated example of FIG. 2, operation of the application layer-capable device 200 has been described from the perspective of transmitting a packet flow. In the illustrated example, to receive a packet flow according to examples disclosed herein, the example application layer-capable device 200 operates in reverse with respect to the above description of FIG. 2. For example, the transmitter and/or receiver circuitry 232 receives a packet flow and the rate computation circuitry 226 determines a bitrate by which the packet flow is to be transmitted by the transmitter and/or receiver circuitry 232. The example bitrate is based on a predicted delay for the packet flow (and/or a delay measurement for any preceding hops by the packet flow) and a predicted utilization of a queue of the receiving device by the packet flow (and/or a current utilization of the queue by other packet flows).

Additionally, for example, after determining the bitrate, if the device includes processing capacity (e.g., on-board accelerator circuitry), the flow to operation mapping circuitry 216 can convert the packet flow to one or more application layer packets. Furthermore, the operation scheduling circuitry 212 can determine one or more operations according to which the one or more application layer packets are to be processed and store the one or more application layer packets in an RQ of the command and completion queues 210. Subsequently, the application execution circuitry 208 can process the one or more application layers packets and then return the packets to the NIC 220 as described above to be transmitted to the next device in a communication path of the packet flow.

In some examples, the application layer-capable device 200 includes circuitry to discover one or more INC capabilities of an IN device and/or to select a communication path for a packet flow through a network based on the one or more INC capabilities of an IN device and/or one or more workload parameters of a packet flow. For example, such circuitry operates in the middle layer 204. In the example of FIG. 2, to discover one or more INC capabilities of an IN device, circuitry of the application layer-capable device 200 operating in the middle layer 204 exchanges one or more messages including application contextual information or communication history with the neighboring devices in the network. As such, circuitry of the application layer-capable device 200 operating in the middle layer 204 can discover potential communication paths via neighboring devices.

Additionally, circuitry of the application layer-capable device 200 operating in the middle layer 204 can implement an Artificial Intelligence/Machine Learning (AI/ML) model to predict (e.g., current or alternative) communication loss in advance to select or switch to alternative communication path earlier. When the AI/ML model predicts loss of all and/or greater than a threshold amount of communication, circuitry of the application layer-capable device 200 operating in the middle layer 204 may buffer latency-insensitive packets and/or traffic during a connection loss period. Furthermore, circuitry of the application layer-capable device 200 operating in the middle layer 204 may map a packet (e.g., original, duplicate, or repetition packets) to primary and/or alternate communication path and add metadata to packets to enable application-aware treatment of packets at the lower layers (e.g., e.g., the transport layer 206, etc.). For example, circuitry operating in the transport layer 206 uses this information to decide duplication/retransmission, coordinated flow control (e.g., treating a number of packets as a group if end-to-end service experience jointly depends on a group of packets), self-decodable segmentation, and congestion control strategy. Additionally, network layers may use this information to select a device for the next hop.

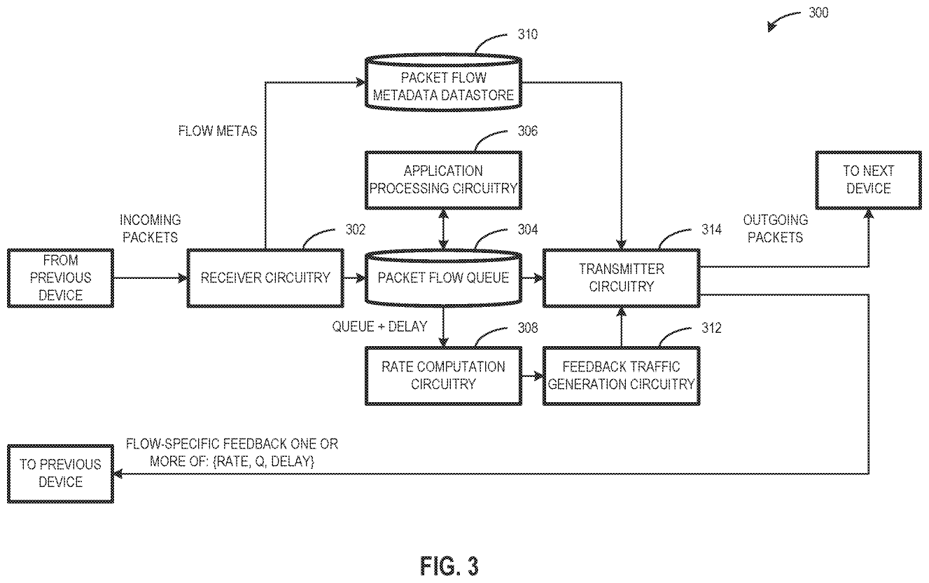

FIG. 3 is a block diagram of an example implementation of an example feedback-capable device 300 of the multi-tier network 100 of FIG. 1. In some examples, the feedback-capable device 300 implements an IN device in the multi-tier network 100 of FIG. 1. In some examples, the feedback-capable device 300 implements an EH device in the multi-tier network 100 of FIG. 1. The example of FIG. 3 depicts a block diagram of the feedback-capable device 300 to perform rate computation and feedback (e.g., instant feedback) for one-hop, multi-hop and/or E2E packet flows to aid in congestion control in the multi-tier network 100 of FIG. 1.

In the illustrated example of FIG. 3, the feedback-capable device 300 includes example receiver circuitry 302, an example packet flow queue 304, example application processing circuitry 306, example rate computation circuitry 308, an example packet flow metadata datastore 310, example feedback traffic generation circuitry 312, and example transmitter circuitry 314. In the example of FIG. 3, the feedback-capable device 300 may be instantiated (e.g., creating an instance of, bring into being for any length of time, materialize, implement, etc.) by programmable circuitry such as a Central Processor Unit (CPU) executing first instructions. Additionally or alternatively, the feedback-capable device 300 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions.

It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

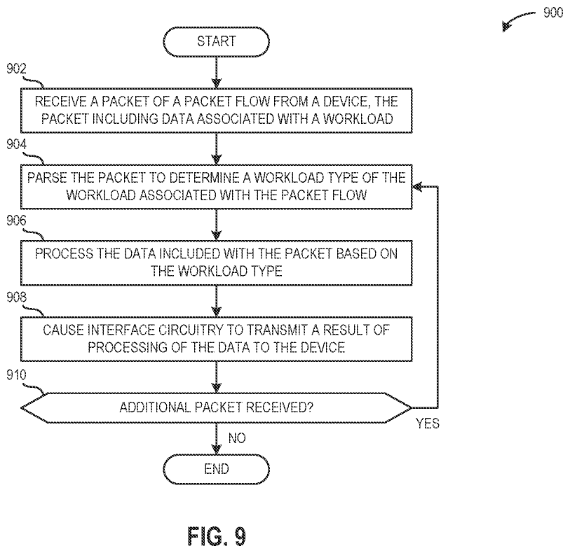

In the illustrated example of FIG. 3, the receiver circuitry 302 is coupled to the packet flow queues 304 and the packet flow metadata datastore 310. In some examples, the receiver circuitry 302 is instantiated by programmable circuitry executing rate computing instructions and/or configured to perform operations such as those represented by the flowchart of FIG. 9. In example operation of the feedback-capable device 300, the receiver circuitry 302 receives one or more packets and loads the one or more packets into the packet flow queue 304. In the example of FIG. 3, the receiver circuitry 302 applies a first timestamp to an initial packet of a packet flow when the initial packet is received by the receiver circuitry 302. Additionally, the receiver circuitry 302 determines metadata included with one or more packets and stores the metadata in the packet flow metadata datastore 310 with an associated flow ID to identify the packet flow with which the metadata is associated.

In some examples, the feedback-capable device 300 includes means for receiving a packet. For example, the means for receiving a packet may be implemented by the receiver circuitry 302. In some examples, the receiver circuitry 302 may be instantiated by programmable circuitry such as the example programmable circuitry 1412 of FIG. 14. For instance, the receiver circuitry 302 may be instantiated by the example microprocessor 1500 of FIG. 15 executing machine-executable instructions such as those implemented by at least blocks 902 and 910 of FIG. 9. In some examples, the receiver circuitry 302 may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the receiver circuitry 302 may be instantiated by any other combination of hardware, software, and/or firmware. For example, the receiver circuitry 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 3, the packet flow queue 304 is coupled to the receiver circuitry 302, the application processing circuitry 306, the rate computation circuitry 308, and the transmitter circuitry 314. In the example of FIG. 3, the feedback-capable device 300 includes the packet flow queue 304 to record data (e.g., one or more transport layer packets, one or more packet flows, etc.) to be transmitted through the multi-tier network 100 and/or to be processed by compute circuitry (not illustrated) of the feedback-capable device 300 before being transmitted through the multi-tier network 100. In the example of FIG. 3, the packet flow queue 304 applies a second timestamp to an initial packet of a packet flow when the initial packet is enqueued in the packet flow queue 304. Additionally, the packet flow queue 304 applies a third timestamp to a final packet of a packet flow when the final packet is dequeued from the packet flow queue 304.

In the illustrated example of FIG. 3, the packet flow queue 304 may be implemented by a volatile memory (e.g., a SDRAM, DRAM, RDRAM, etc.) and/or a non-volatile memory (e.g., flash memory). The packet flow queue 304 may additionally or alternatively be implemented by one or more DDR memories, such as DDR, DDR2, DDR3, DDR4, DDR5, mDDR, DDR SDRAM, etc. The packet flow queue 304 may additionally or alternatively be implemented by one or more mass storage devices such as HDD(s), CD drive(s), DVD drive(s), SSD drive(s), SD card(s), CF card(s), etc. While in the illustrated example the packet flow queue 304 is illustrated as one queue, the packet flow queue 304 may be implemented by any number and/or type(s) of queues. Furthermore, the data stored in the packet flow queue 304 may be in any data format such as, for example, binary data, comma delimited data, tab delimited data, SQL structures, etc.

In the illustrated example of FIG. 3, the application processing circuitry 306 is coupled to the packet flow queue 304. In some examples, the application processing circuitry 306 is instantiated by programmable circuitry executing application processing instructions and/or configured to perform operations such as those represented by the flowchart of FIG. 9. In example operation of the feedback-capable device 300, the application processing circuitry 306 parses one or more packets in the packet flow queue 304 to determine respective IDs (e.g., class IDs, workload IDs, application IDs, etc.) included with the one or more packets. For example, by parsing a packet for a workload ID, the application processing circuitry 306 determines a workload type of a workload associated with the packet. Example workload types include workloads related to low latency applications (e.g., online meetings, online gaming, high frequency trading, etc.), workload related to long tail applications (e.g., application introducing long tail latency such as applications introducing latency times in the 98^{th} percentile as compared to average latency times), and workloads related to and/or arising from an application implemented on an endpoint device, and EH device, and/or an IN device (e.g., location services applications, social media applications, etc.). Additionally or alternatively, an example workload type includes a compression and/or decompression workload, an encryption workload, a scatter/gather workload, a load balancing workload, a network address translation workload, a domain name system (DNS) server workload, a caching workload, a data reduction workload (e.g., a workload related to reducing the amount of data transmitted from an in-network device to another device along a communication path), a data aggregation workload (e.g., a workload related to aggregating a batch of data at an in-network device), among others.

In the illustrated example of FIG. 3, by ascertaining the workload type of a workload associated with a packet or packet flow, the application processing circuitry 306 determines how one or more packets of the packet flow are to be interpreted when processed by the application processing circuitry 306. Accordingly, the application processing circuitry 306 processes data included in a received packet based on the workload type of a workload associated with the packet. For example, the application processing circuitry 306 performs a portion of the workload associated with the packet flow, performs the entirety of the workload associated with the packet flow, and/or performs some additional or alternative operations (e.g., a compression and/or decompression operation, an encryption operation, a scatter/gather operation, a load balancing operation, a network address translation operations, a DNS server operation, a caching operation, a data reduction operation, a data aggregation operation, etc.) on the packet flow.

After processing data included in a packet of a packet flow, the application processing circuitry 306 loads the result into the packet flow queue 304 to be forwarded to another device in a communication path of the packet flow or returned to an EH device that requested IN processing. In this manner, the application processing circuitry 306 causes the transmitter circuitry 314 to transmit the result to another device in the multi-tier network 100. Additionally, after processing data included in a packet of a packet flow, the application processing circuitry 306 modifies the packet to indicate that an action has been performed on the packet. For example, there may only be a preset list of operations, functions, primitives, and/or processing that IN devices can perform on a packet. By modifying an indicator field of the packet based on the operation performed on the packet, the application processing circuitry 306 can identify the operation performed on the packet to the next device in the communication path of the packet.

In some examples, the indicator field may be implemented by adjusting the field including a class ID, a workload ID, and/or an application ID of a packet. For example, the application processing circuitry 306 may modify a packet after performing an action on the packet by removing the information in the field including a class ID, a workload ID, and/or an application ID of the packet. In this manner, a subsequent device in the communication path of the packet will not repeat the action performed on the packet by the application processing circuitry 306. In additional or alternative examples, the indicator field may be implemented as an explicit field that includes information mapping to the preset list of operations, function, primitives, and/or processing that IN devices can perform on a packet. For example, if the preset list of operations, functions, primitives, and/or processing that IN devices can perform on a packet is mapped to a lookup table (LUT), then the application processing circuitry 306 sets a value in the indicator field that maps to the corresponding action in the LUT that was performed on the packet. Additionally or alternatively, the feedback-capable device 300 may transmit an additional packet to the next device in a communication path of a packet to identify the action performed on the packet by the feedback-capable device 300.

In such examples, a subsequent device in a communication path of a packet can also implement the LUT and/or signaling to identify an action performed on a packet as well as a hop count or forwarding device ID. After a device (e.g., an IN device and/or an EH device) receives a packet that has been operated on by a preceding device in a communication path of the packet, the device picks up a workload where the preceding device left off. Additionally, in addition to workload-related operations, the device performs additional operations on a per workload basis. Such operations include latency-related operations, queue control- and/or update-related operations, and/or scaling-related operations to meet demands of the workload (e.g., to meet QoS requirements specified by an SLA and/or a service level objective (SLO) associated with the workload).

In some examples, the feedback-capable device 300 includes means for processing a packet. For example, the means for processing a packet may be implemented by the application processing circuitry 306. In some examples, the application processing circuitry 306 may be instantiated by programmable circuitry such as the example programmable circuitry 1412 of FIG. 14. For instance, the application processing circuitry 306 may be instantiated by the example microprocessor 1500 of FIG. 15 executing machine-executable instructions such as those implemented by at least blocks 904, 906, and 908 of FIG. 9. In some examples, the application processing circuitry 306 may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the application processing circuitry 306 may be instantiated by any other combination of hardware, software, and/or firmware. For example, the application processing circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

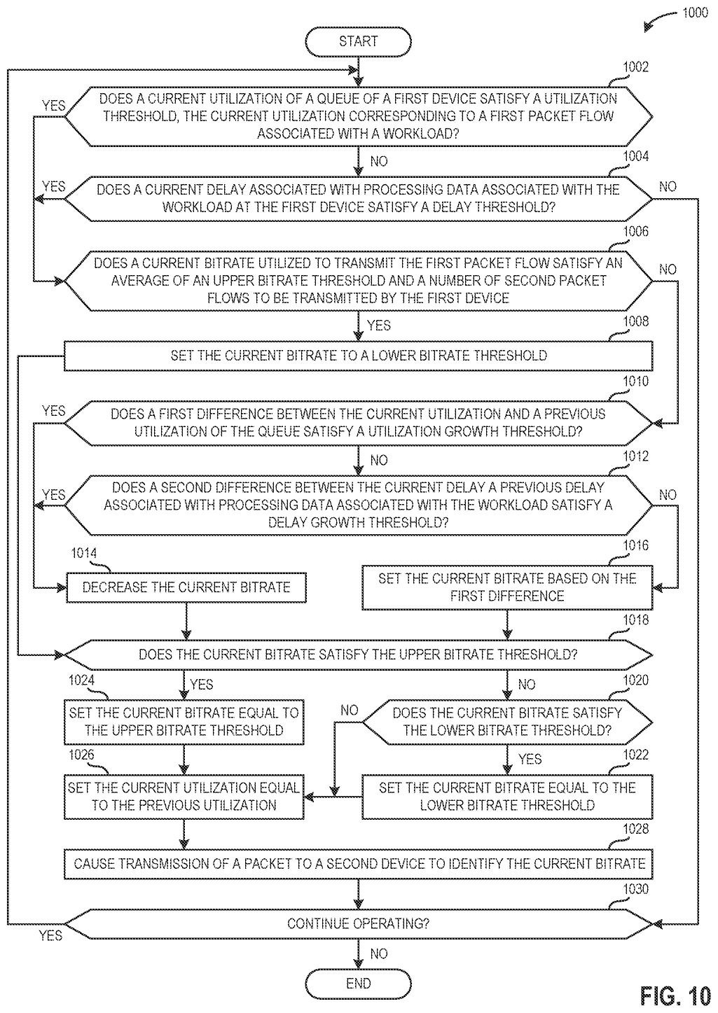

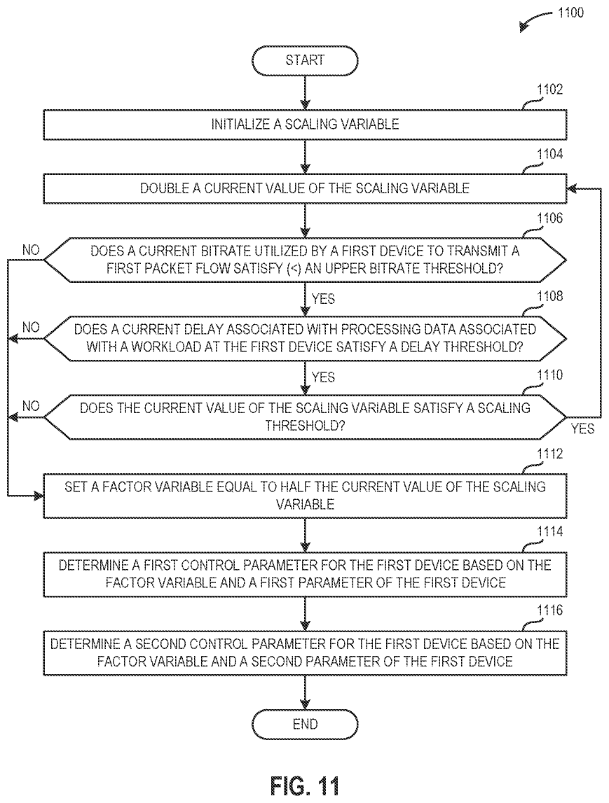

In the illustrated example of FIG. 3, the rate computation circuitry 308 is coupled to the packet flow queue 304 and the feedback traffic generation circuitry 312. In some examples, the rate computation circuitry 308 is instantiated by programmable circuitry executing rate computing instructions and/or configured to perform operations such as those represented by the flowcharts of FIGS. 10 and 11. In example operation of the feedback-capable device 300, the rate computation circuitry 308 computes (e.g., periodically, on a trigger (e.g., a trigger from a source device), etc.) a bitrate utilized by the feedback-capable device 300 to transmit a packet flow and sends a feedback packet to a source device via one or more hops to identify the bitrate to the source device.

In the illustrated example of FIG. 3, as described above, a packet flow received and transmitted by the feedback-capable device 300 is associated with a workload. Additionally, as described above, the feedback-capable device 300 includes the application processing circuitry 306 which is capable of performing application-level processing on data included in the packet flow. In the example of FIG. 3, the rate computation circuitry 308 determines a delay associated with processing data associated with the workload at the feedback-capable device 300. For example, the delay can be computed on a per packet flow basis where respective delays correspond to a delay associated with processing data associated with a workload with which a packet flow is associated. Additionally or alternatively, the delay can be computed as a composite measurement of the delay for processing data at the feedback-capable device 300 over a period of time. In some examples, the delay can be computed on a per packet basis. In the example of FIG. 3, to determine a delay associated with processing data associated with the workload at the feedback-capable device 300, the rate computation circuitry 308 determines a difference between a total delay at the feedback-capable device 300 for a packet flow and a queuing delay at the packet flow queue 304 for the packet flow.

For example, when the final packet of a packet flow is transmitted by the transmitter circuitry 314, the rate computation circuitry 308 determines a fourth timestamp for the final packet. To determine the total delay at the feedback-capable device 300 for a packet flow, the rate computation circuitry 308 determines a difference between the fourth timestamp (e.g., the transmit time) of a final packet of the packet flow and the first timestamp (e.g., the receive time) of an initial packet of the packet flow. Additionally or alternatively, the rate computation circuitry 308 can determine the total delay at the feedback-capable device 300 by starting a timer (e.g., a counter) at the receive time and stopping the timer at the transmit time. In the example of FIG. 3, to determine the queuing delay, the rate computation circuitry 308 determines the difference between the third timestamp (e.g., the dequeue time) of the final packet of the packet flow and the second timestamp (e.g., the enqueue time) of the initial packet of the packet flow. Additionally or alternatively, the rate computation circuitry 308 can determine the queueing delay associated with the packet flow queue 304 by starting a timer (e.g., a counter) at the enqueue time and stopping the timer at the dequeue time.

In the illustrated example of FIG. 3, the rate computation circuitry 308 determines a bitrate (e.g., fair rate) that the transmitter circuitry 314 is to utilize to transmit a packet flow based on a utilization of the packet flow queue 304 by the packet flow (e.g., a queue size for the packet flow) and a delay associated with processing data of the packet flow at the feedback-capable device 300. As such, the rate computation circuitry 308 accounts for queuing delay and processing delay (e.g., computing delay) at the feedback-capable device 300 while computing the bitrate for a packet flow. In some examples, the rate computation circuitry 308 compares the bitrate to an upper bitrate threshold and a lower bitrate threshold for the feedback-capable device 300. FIG. 10 illustrates example machine-readable instructions and/or example operations to compute a bitrate to be utilized to transmit a packet flow based on in-network computation delay.

In some examples, the rate computation circuitry 308 implements approximate fair dropping (AFD) based on queue utilization by packets flows and processing delays for the packet flows. For example, evaluates a first delay associated with processing data of a first packet flow and a second delay associated with processing data of a second packet flow. Based on the first delay being greater than the second delay, the rate computation circuitry 308 decreases a bitrate to be utilized to transmit the second packet flow so that a bitrate utilized to transmit the first packet flow can be increased. In general, the rate computation circuitry 308 can prioritize bitrates allocated to packet flows in increasing order of the data tuple of utilization of the packet flow queue 304 by a packet flow and processing delay associated with processing data of the packet flow (e.g., [packet flow queue utilization, packet flow processing delay]). In the example of FIG. 3, the rate computation circuitry 308 forwards the bitrate to the feedback traffic generation circuitry 312.

In some examples, the feedback-capable device 300 includes means for computing a bitrate. For example, the means for computing a bitrate may be implemented by the rate computation circuitry 308. In some examples, the rate computation circuitry 308 may be instantiated by programmable circuitry such as the example programmable circuitry 1412 of FIG. 14. For instance, the rate computation circuitry 308 may be instantiated by the example microprocessor 1500 of FIG. 15 executing machine-executable instructions such as those implemented by at least blocks 1002, 1004, 1006, 1008, 1010, 1012, 1014, 1016, 1018, 1020, 1022, 1024, 1026, and 1030 of FIG. 10 and/or at least blocks 1102, 1104, 1106, 1108, 1110, 1112, 1114, and 1116 of FIG. 11. In some examples, the rate computation circuitry 308 may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the rate computation circuitry 308 may be instantiated by any other combination of hardware, software, and/or firmware. For example, the rate computation circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 3, the packet flow metadata datastore 310 is coupled to the receiver circuitry 302 and the transmitter circuitry 314. In the example of FIG. 3, the feedback-capable device 300 includes the packet flow metadata datastore 310 to record data associated with one or more packets received at the feedback-capable device 300. For example, the packet flow metadata datastore 310 maintains a flow table that identifies respective packet flows associated with packets received by the feedback-capable device 300 and other metadata indicative of characteristics of the respective packet flows. Example metadata includes a flow ID of a packet flow, a feedback flag for the packet flow, a bitrate utilized by a source device to transmit the packet flow, a utilization of a queue of the source device by the packet flow (e.g., queue size for the packet flow), a delay measurement for transmitting the packet flow through a network, an ID of the source device of the packet flow, and an ID of a destination device of the packet flow.

In the illustrated example of FIG. 3, a feedback flag indicates whether a source device of a packet flow requested feedback associated with the packet flow. In examples disclosed herein, a feedback flag can be implemented as a binary variable. An example flow table is illustrated in Table 1 below. As illustrated below, the flow table maintained by the packet flow metadata datastore 310 allows the feedback-capable device 300 to track which devices are to receive feedback messages.

TABLE 1

| Flow | Feedback | | | Transmission | Source | Destination |
|---|---|---|---|---|---|---|
| ID | Flag | Bitrate | Queue Size | Delay | Device ID | Device ID |
| A | 0 | 250 megabits per | 50 megabytes | 100 microseconds | A1 | A2 |
| | | second (Mbps) | (MBs) | (μs) | | |
| B | 1 | 500 Mbps | 100 MBs | 200 μs | B1 | B2 |

In the example of FIG. 3, the size of the flow table maintained by the packet flow metadata datastore 310 is bounded by the data tuple of the packet flow queue 304 and processing delay associated with the feedback-capable device 300 (e.g., [size of the packet flow queue 304, processing delay associated with the feedback-capable device 300]). As described above, the delay may be computed on a per packet basis, a per packet flow basis, and/or as a composite measurement for processing data at the feedback-capable device 300. In the example of FIG. 3, the feedback-capable device 300 sizes the flow table based on the size of the packet flow queue 304 and the delay associated with processing data at the feedback-capable device 300.

For example, the flow table maintained by the packet flow metadata datastore 310 can store metadata for a limited number of packet flows based on the size of the packet flow queue 304. By implementing a lower bitrate threshold for the rate computation circuitry 308, as described above, the flow table maintained by the packet flow metadata datastore 310 has an upper bound on the number of concurrent packet flows that can be supported by the feedback-capable device 300. Additionally, the packet flow metadata datastore 310 may consider packet flow delay when sizing the flow table. As such, the packet flow metadata datastore 310 may evict packet flows from the flow table based on the data tuple of the size of the packet flow queue 304 and processing delay associated with the feedback-capable device 300 (e.g., [size of the packet flow queue 304, processing delay associated with the feedback-capable device 300]). In additional or alternative examples, the flow table may be implemented differently provided the additional or alternative implementations jointly incorporate delay and queuing sate information that can be utilized for filtering the flows.

In the illustrated example of FIG. 3, the packet flow metadata datastore 310 may be implemented by a volatile memory (e.g., a SDRAM, DRAM, RDRAM, etc.) and/or a non-volatile memory (e.g., flash memory). The packet flow metadata datastore 310 may additionally or alternatively be implemented by one or more DDR memories, such as DDR, DDR2, DDR3, DDR4, DDR5, mDDR, DDR SDRAM, etc. The packet flow metadata datastore 310 may additionally or alternatively be implemented by one or more mass storage devices such as HDD(s), CD drive(s), DVD drive(s), SSD drive(s), SD card(s), CF card(s), etc. While in the illustrated example the packet flow metadata datastore 310 is illustrated as a single datastore, the packet flow metadata datastore 310 may be implemented by any number and/or type(s) of datastores. Furthermore, the data stored in the packet flow metadata datastore 310 may be in any data format such as, for example, binary data, comma delimited data, tab delimited data, SQL structures, etc.

In the illustrated example of FIG. 3, the feedback traffic generation circuitry 312 is coupled to the rate computation circuitry 308 and the transmitter circuitry 314. In some examples, the feedback traffic generation circuitry 312 is instantiated by programmable circuitry executing feedback generation instructions and/or configured to perform operations such as those represented by the flowchart of FIG. 10. In example operation of the feedback-capable device 300, the feedback traffic generation circuitry 312 generates a feedback message (e.g., one or more feedback packets) and causes transmission of the feedback message to the source device of a packet flow or the prior immediate neighboring device in the communication path so that the feedback message can be relayed to the source device.

For example, if the prior immediate neighboring device is not the source device, the feedback traffic generation circuitry 312 causes transmission of the feedback message to the prior immediate neighboring device in the communication path so that the feedback message can be relayed to the source device. In some examples, the feedback message is referred to as a congestion notification packet (CNP). As such, the source device can utilize the CNP to reduce (e.g., minimize) the queue buildup at the feedback-capable device 300 by rate control at the source device. In the example of FIG. 3, the CNP encapsulates the fair rate to be utilized by the feedback-capable device 300 to transmit a packet flow and a flow ID for the packet flow. For example, the CNP can include a data tuple indicating (a) the bitrate to be utilized by the feedback-capable device 300 to transmit a packet flow, (b) utilization of the packet flow queue 304 by the packet flow, (c) processing delay associated with processing data of the packet flow at the feedback-capable device 300, (d) a flow ID for the packet flow, (e) an ID of a source device of the packet flow, and (f) an ID of a destination device of the packet flow (e.g., [packet flow bitrate, packet flow queue utilization, packet flow processing delay, flow ID, source ID, destination ID]).

In some examples, the feedback-capable device 300 includes means for generating feedback. For example, the means for generating feedback may be implemented by the feedback traffic generation circuitry 312. In some examples, the feedback traffic generation circuitry 312 may be instantiated by programmable circuitry such as the example programmable circuitry 1412 of FIG. 14. For instance, the feedback traffic generation circuitry 312 may be instantiated by the example microprocessor 1500 of FIG. 15 executing machine-executable instructions such as those implemented by at least block 1028 of FIG. 10. In some examples, the feedback traffic generation circuitry 312 may be instantiated by hardware logic circuitry, which may be implemented by an ASIC, XPU, or the FPGA circuitry 1600 of FIG. 16 configured and/or structured to perform operations corresponding to the machine-readable instructions. Additionally or alternatively, the feedback traffic generation circuitry 312 may be instantiated by any other combination of hardware, software, and/or firmware. For example, the feedback traffic generation circuitry 312 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

As described in FIG. 3, the flow table implemented by the packet flow metadata datastore 310 facilitates sending feedback messages (CNPs) for selected packet flows (e.g., elephant flows). For example, the rate computation circuitry 308 changes the fair rate for a congested packet flow until the arrival rate for the congested packet flow matches the drain rate from the packet flow queue 304 for the congested packet flow. As such, the fair rate for the congested packet flow will stabilize as

$$F = \frac{{C}_{l} - B {R}_{m i c e}}{N} ,$$

where Cₗ represents the bandwidth of the feedback-capable device 300, BW_{mice} represents the bandwidth of the feedback-capable device 300 allocated to packet flows that do not contribute to congestion (e.g., mice flows), and N is the number of packet flows contributing to congestion. Accordingly, the rate computation circuitry 308 tracks packet flows that contribute to congestion and queue build up at the feedback-capable device 300.

In the illustrated example of FIG. 3, the transmitter circuitry 314 is coupled to the packet flow queue 304, the packet flow metadata datastore 310, and the feedback traffic generation circuitry 312. In example operation of the feedback-capable device 300, the transmitter circuitry 314 transmits packets of a packet flow at the bitrate specified by the rate computation circuitry 308. For example, the transmitter circuitry 314 transmits the packets of the packet flow to the next device in a communication path of the packet flow. Additionally, the transmitter circuitry 314 also transmits a CNP to the previous device in the communication path.

In some examples, the feedback-capable device 300 includes circuitry to communicate one or more INC capabilities of the feedback-capable device 300 to communicate the one or more INC capabilities of the feedback-capable device 300 to an EH device. For example, such circuitry operates in the middle layer of the feedback-capable device 300. In the example of FIG. 3, circuitry of the feedback-capable device 300 operating in the middle layer exchanges one or more messages including application contextual information or communication history with the neighboring devices in the network. As such, circuitry of the feedback-capable device 300 operating in the middle layer facilitate an EH device discovering potential communication paths via neighboring devices.

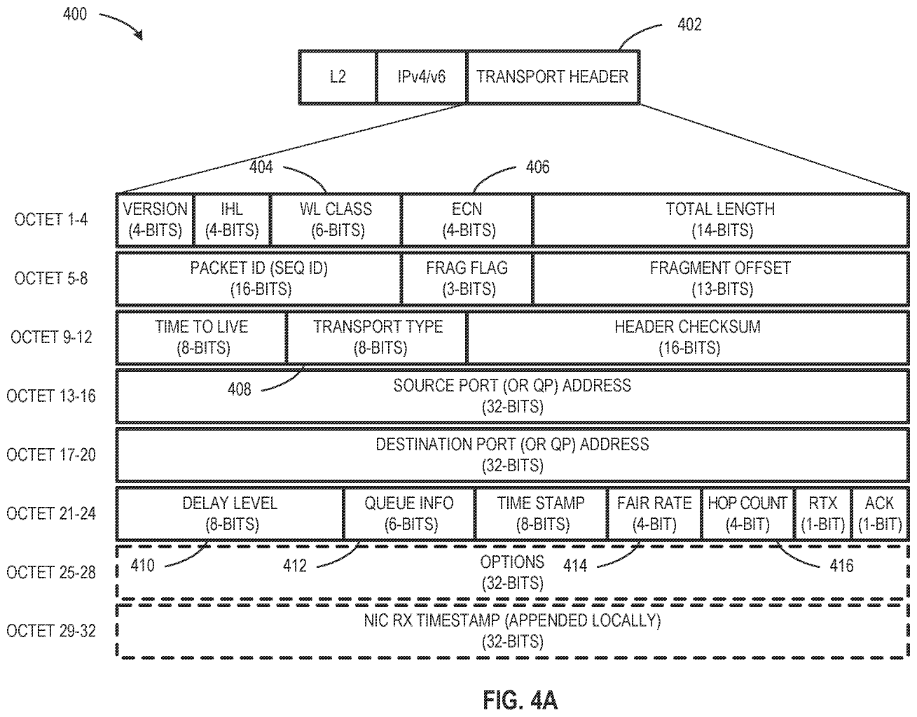

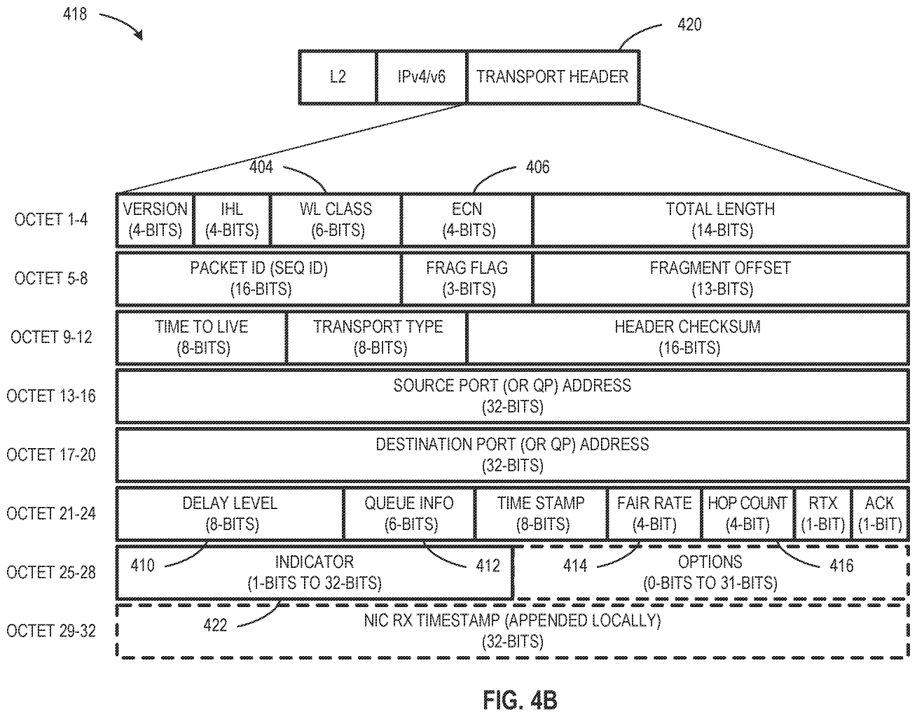

FIG. 4A is an illustration of an example packet 400 including an example header 402 (e.g., a transport header) in accordance with examples disclosed herein. For example, the packet 400 corresponds to a packet traversing the communication path from a source device, through one or more IN devices, to a destination device and/or vice versa. In the example of FIG. 4A, the header 402 include an example workload (WL) class field 404, an example explicit congestion notification (ECN) field 406, an example transport type field 408, an example delay level field 410, an example queue information field 412, an example fair rate field 414, and an example hop count field 416.

In the illustrated example of FIG. 4A, the workload class field 404 (e.g., a header field) is a 6-bit field that indicates a WL class with which the packet 400 is associated. For example, the WL class field 404 operates as a flag to allow an IN device to opportunistically perform one or more operations (e.g., primitives, transport type functions, etc.) related to the workload class. In some examples, a device can modify the WL class field 404 after performing an action on the packet 400 by removing the information in the WL class field 404. In this manner, a subsequent device in the communication path of the packet 400 will not repeat the action performed on the packet 400. In the example of FIG. 4A, the ECN field 406 is a 4-bit field that indicates whether one or more of the first ECN flag or the second ECN flag is set for the packet 400. For example, if both the first ECN flag and the second ECN flag are set, one bit of the ECN field 406 (e.g., a binary value) can be utilized to indicate the status of the first and second ECN flag. Additionally or alternatively, if one or both of the first ECN flag and the second ECN flag are set, multiple bits of the ECN field 406 can be utilized to indicate the status of the first and second ECN flag.

In the illustrated example of FIG. 4A, the transport type field 408 is an 8-bit field that indicates a transport type with which the packet 400 is associated. In some examples, the transport type field 408 (e.g., a transport type header field and/or an application type header field) depends on the WL class identified in the WL class field 404 (e.g., a workload class header field). As such, when a device receives the packet 400, the WL class field 404 and/or the transport type field 408 of the packet 400 can trigger a specific type of transport protocol corresponding to different types of application layer WL classes ranging from networking delay and/or congestion sensitive applications to processing time sensitive flows. Example transport types include transmission control protocol (TCP), user datagram protocol (UDP), stream control transmission protocol (SCTP), datagram congestion control protocol (DCCP), remote desktop protocol (RDP), and reliable user datagram protocol (RUDP). Other examples of transport types include custom transports such as those provided by InfiniBand and Google.

In the illustrated example of FIG. 4A, the delay level field 410 is an 8-bit field indicative of the processing delay associated with a packet flow with which the packet 400 is associated. For example, the processing delay represented in the delay level field 410 corresponds to the delay associated with processing data associated with a workload at a device transmitting the packet 400 where the packet 400 is associated with the workload. Based on the processed delay communicated in the delay level field 410, an E2E delay at EH devices can be computed (e.g., an RTT delay). To implement the delay level field 410, once the packet 400 traverses from ingress to egress of a device (e.g., from a receiver of a device to a transmitter of a device), the processing delay is available at the device. As such, the device appends the delay level field 410 to the header 402. In the example of FIG. 4A, the delay level field 410 is quantized in bits. In the example of FIG. 4A, the queue information field 412 is a 6-bit field representative of the utilization of a queue of a source device of the packet 400.

In the illustrated example of FIG. 4A, the fair rate field 414 is a 4-bit field indicative of the bitrate utilized by the source device to transmit the packet 400. In the example of FIG. 4A, the fair rate field 414 may be updated after the source device receives a CNP. Additionally, the example hop count field 416 is a 4-bit field indicative of a relaying and/or routing history of the path traversed by the packet 400. As such, the hop count field 416 retains network topology awareness. The example of FIG. 4A illustrates example sizes of the data fields of the header 402. In additional or alternative examples, any of the data fields of the header 402 may have different sizes.

As illustrated in FIG. 4A, the header 402 includes first header fields (e.g., the WL class field 404, the ECN field 406, the transport type field 408, the delay level field 410, the queue information field 412, the fair rate field 414, and the hop count field 416). Additionally, the header 402 includes second header fields (e.g., a version field, an Internet header length (IHL) field, a total length field, a packet identifier (ID) field, a fragment (frag) flag field, a fragment offset field, a time to live field, a header checksum field, a source port address field, a destination port address field, a time stamp field, a retransmission (RTX) field, an acknowledgement (ACK) field, an options field, a NIC receiver (RX) timestamp field, etc.). In the example of FIG. 4A, the first header fields are related to in-network computation and control of network congestion based on in-network computation delays. Additionally, in the example of FIG. 4A, one or more of the second header fields is related to a protocol for communication of the packet 400.

FIG. 4B is another illustration of an example packet 418 including an example header 420 in accordance with examples disclosed herein. For example, the packet 418 corresponds to a packet traversing the communication path from a source device, through one or more IN devices, to a destination device and/or vice versa. In the example of FIG. 4B, the header 420 include the example WL class field 404, the example ECN field 406, the example transport type field 408, the example delay level field 410, the example queue information field 412, the example fair rate field 414, and the example hop count field 416. In the example of FIG. 4B, the header 420 include an example indicator field 422 which may implemented in addition to or instead of the options field described above. For example, the indicator field 422 may be between one and 32 bits in length.

As illustrated in FIG. 4B, the header 420 includes first header fields (e.g., the WL class field 404, the ECN field 406, the transport type field 408, the delay level field 410, the queue information field 412, the fair rate field 414, the hop count field 416, and the indicator field 422). Additionally, the header 420 includes second header fields (e.g., a version field, an IHL field, a total length field, a packet ID field, a frag flag field, a fragment offset field, a time to live field, a header checksum field, a source port address field, a destination port address field, a time stamp field, a RTX field, an ACK field, an options field, a NIC RX timestamp field, etc.). In the example of FIG. 4B, the first header fields are related to in-network computation and control of network congestion based on in-network computation delays. Additionally, in the example of FIG. 4B, one or more of the second header fields is related to a protocol for communication of the packet 418.

In the example of FIG. 4B, the indicator field 422 is implemented as an explicit field that includes information mapping to a preset list of operations, function, primitives, and/or processing that IN devices can perform on a packet. For example, the device transmitting the packet 418 sets a value in the indicator field 422 that maps to a corresponding action in a LUT of the device that was performed on the packet 418. Additionally or alternatively, the indicator field 422 is implemented as an explicit completion flag. For example, the device transmitting the packet 418 sets an explicit completion flag (e.g., a 1 bit field) in the indicator field 422 that specifies a status of an associated workload (e.g., whether or not the workload was completed or processed at all during transit).

While an example manner of implementing the application layer-capable device 200 of FIG. 2 is illustrated in FIG. 2, one or more of the elements, processes, and/or devices illustrated in FIG. 2 may be combined, divided, re-arranged, omitted, eliminated, and/or implemented in any other way. Additionally, while an example manner of implementing the feedback-capable device 300 of FIG. 3 is illustrated in FIG. 3, one or more of the elements, processes, and/or devices illustrated in FIG. 3 may be combined, divided, re-arranged, omitted, eliminated, and/or implemented in any other way. Further, the example application execution circuitry 208, the example command and completion queues 210, the example operation scheduling circuitry 212, the example operation to flow mapping circuitry 214, the example flow to operation mapping circuitry 216, and/or, the example delay determination circuitry 222, the example queue analysis circuitry 224, the example rate computation circuitry 226, the example pacing circuitry 228, and/or, more generally, the example congestion control circuitry 218, and/or, the example NIC queues 230, the example transmitter and/or receiver circuitry 232, and/or, more generally, the example NIC 220, and/or, more generally, the application layer-capable device 200 of FIG. 2, and/or the example receiver circuitry 302, the example packet flow queue 304, the example application processing circuitry 306, the example rate computation circuitry 308, the example packet flow metadata datastore 310, the example feedback traffic generation circuitry 312, the example transmitter circuitry 314, and/or, more generally, the example feedback-capable device 300 of FIG. 3, may be implemented by hardware alone or by hardware in combination with software and/or firmware. Thus, for example, any of the example application execution circuitry 208, the example command and completion queues 210, the example operation scheduling circuitry 212, the example operation to flow mapping circuitry 214, the example flow to operation mapping circuitry 216, and/or, the example delay determination circuitry 222, the example queue analysis circuitry 224, the example rate computation circuitry 226, the example pacing circuitry 228, and/or, more generally, the example congestion control circuitry 218, and/or, the example NIC queues 230, the example transmitter and/or receiver circuitry 232, and/or, more generally, the example NIC 220, and/or, more generally, the application layer-capable device 200 of FIG. 2, and/or the example receiver circuitry 302, the example packet flow queue 304, the example application processing circuitry 306, the example rate computation circuitry 308, the example packet flow metadata datastore 310, the example feedback traffic generation circuitry 312, the example transmitter circuitry 314, and/or, more generally, the example feedback-capable device 300 of FIG. 3, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example application layer-capable device 200 of FIG. 2 may include one or more elements, processes, and/or devices in addition to, or instead of, those illustrated in FIG. 2, and/or may include more than one of any or all of the illustrated elements, processes, and devices. Additionally, the example feedback-capable device 300 of FIG. 3 may include one or more elements, processes, and/or devices in addition to, or instead of, those illustrated in FIG. 3, and/or may include more than one of any or all of the illustrated elements, processes, and devices.

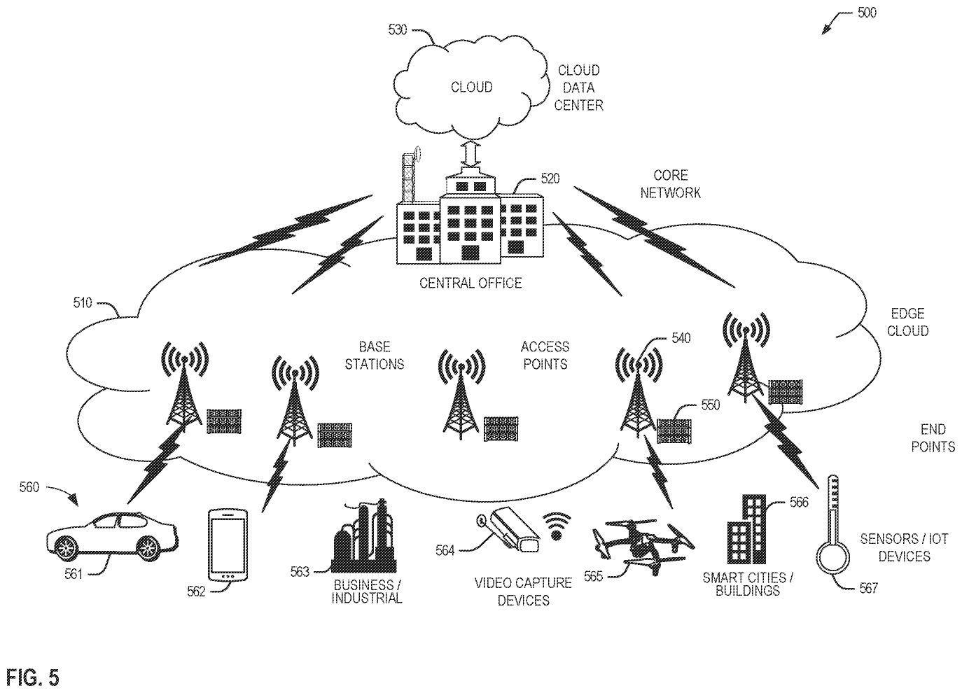

FIG. 5 is a block diagram 500 showing an overview of a configuration for Edge computing, which includes a layer of processing referred to in many of the following examples as an “Edge cloud”. As shown, the Edge cloud 510 is co-located at an Edge location, such as an access point or base station 540, a local processing hub 550, or a central office 520, and thus may include multiple entities, devices, and equipment instances. The Edge cloud 510 is located much closer to the endpoint (consumer and producer) data sources 560 (e.g., autonomous vehicles 561, user equipment 562, business and industrial equipment 563, video capture devices 564, drones 565, smart cities and building devices 566, sensors and IoT devices 567, etc.) than the cloud data center 530. Compute, memory, and storage resources which are offered at the edges in the Edge cloud 510 are critical to providing ultra-low latency response times for services and functions used by the endpoint data sources 560 as well as reduce network backhaul traffic from the Edge cloud 510 toward cloud data center 530 thus improving energy consumption and overall network usages among other benefits.

Compute, memory, and storage are scarce resources, and generally decrease depending on the Edge location (e.g., fewer processing resources being available at consumer endpoint devices, than at a base station, than at a central office). However, the closer that the Edge location is to the endpoint (e.g., user equipment (UE)), the more that space and power is often constrained. Thus, Edge computing attempts to reduce the amount of resources needed for network services, through the distribution of more resources which are located closer both geographically and in network access time. In this manner, Edge computing attempts to bring the compute resources to the workload data where appropriate or bring the workload data to the compute resources.

The following describes aspects of an Edge cloud architecture that covers multiple potential deployments and addresses restrictions that some network operators or service providers may have in their own infrastructures. These include, variation of configurations based on the Edge location (because edges at a base station level, for instance, may have more constrained performance and capabilities in a multi-tenant scenario); configurations based on the type of compute, memory, storage, fabric, acceleration, or like resources available to Edge locations, tiers of locations, or groups of locations; the service, security, and management and orchestration capabilities; and related objectives to achieve usability and performance of end services. These deployments may accomplish processing in network layers that may be considered as “near Edge,” “close Edge,” “local Edge,” “middle Edge,” or “far Edge” layers, depending on latency, distance, and timing characteristics.

Edge computing is a developing paradigm where computing is performed at or closer to the “Edge” of a network, typically through the use of a compute platform (e.g., x86 or ARM compute hardware architecture) implemented at base stations, gateways, network routers, or other devices which are much closer to endpoint devices producing and consuming the data. For example, Edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within Edge computing networks, there may be scenarios in services in which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

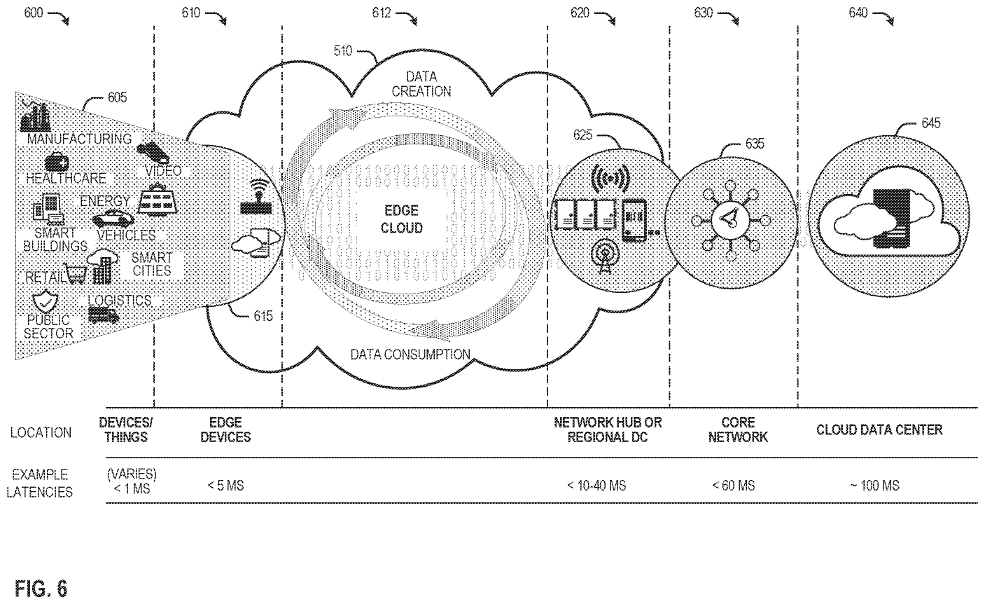

FIG. 6 illustrates operational layers among endpoints, an Edge cloud, and cloud computing environments. Specifically, FIG. 6 depicts examples of computational use cases 605, utilizing the Edge cloud 510 among multiple illustrative layers of network computing. The layers begin at an endpoint (devices and things) layer 600, which accesses the Edge cloud 510 to conduct data creation, analysis, and data consumption activities. The Edge cloud 510 may span multiple network layers, such as an Edge devices layer 610 having gateways, on-premise servers, or network equipment (nodes 615) located in physically proximate Edge systems; a network access layer 620, encompassing base stations, radio processing units, network hubs, regional data centers (DC), or local network equipment (equipment 625); and any equipment, devices, or nodes located therebetween (in layer 612, not illustrated in detail). The network communications within the Edge cloud 510 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 600, under 5 ms at the Edge devices layer 610, to even between 10 to 40 ms when communicating with nodes at the network access layer 620. Beyond the Edge cloud 510 are core network 630 and cloud data center 640 layers, each with increasing latency (e.g., between 50-60 ms at the core network layer 630, to 100 or more ms at the cloud data center layer). As a result, operations at a core network data center 635 or a cloud data center 645, with latencies of at least 50 to 100 ms or more, will not be able to accomplish many time-critical functions of the use cases 605. Each of these latency values are provided for purposes of illustration and contrast; it will be understood that the use of other access network mediums and technologies may further reduce the latencies. In some examples, respective portions of the network may be categorized as “close Edge,” “local Edge,” “near Edge,” “middle Edge,” or “far Edge” layers, relative to a network source and destination. For instance, from the perspective of the core network data center 635 or a cloud data center 645, a central office or content data network may be considered as being located within a “near Edge” layer (“near” to the cloud, having high latency values when communicating with the devices and endpoints of the use cases 605), whereas an access point, base station, on-premise server, or network gateway may be considered as located within a “far Edge” layer (“far” from the cloud, having low latency values when communicating with the devices and endpoints of the use cases 605). It will be understood that other categorizations of a particular network layer as constituting a “close,” “local,” “near,” “middle,” or “far” Edge may be based on latency, distance, number of network hops, or other measurable characteristics, as measured from a source in any of the network layers 600-640.

The various use cases 605 may access resources under usage pressure from incoming streams, due to multiple services utilizing the Edge cloud. To achieve results with low latency, the services executed within the Edge cloud 510 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement actions to remediate.

Thus, with these variations and service features in mind, Edge computing within the Edge cloud 510 may provide the ability to serve and respond to multiple applications of the use cases 605 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of Edge computing comes the following caveats. The devices located at the Edge are often resource constrained and therefore there is pressure on usage of Edge resources. Typically, this is addressed through the pooling of memory and storage resources for use by multiple users (tenants) and devices. The Edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because Edge locations may be unmanned and may even need permissioned access (e.g., when housed in a third-party location). Such issues are magnified in the Edge cloud 510 in a multi-tenant, multi-owner, or multi-access setting, where services and applications are requested by many users, especially as network usage dynamically fluctuates and the composition of the multiple stakeholders, use cases, and services changes.

At a more generic level, an Edge computing system may be described to encompass any number of deployments at the previously discussed layers operating in the Edge cloud 510 (network layers 600-640), which provide coordination from client and distributed computing devices. One or more Edge gateway nodes, one or more Edge aggregation nodes, and one or more core data centers may be distributed across layers of the network to provide an implementation of the Edge computing system by or on behalf of a telecommunication service provider (“telco,” or “TSP”), internet-of-things service provider, cloud service provider (CSP), enterprise entity, or any other number of entities. Various implementations and configurations of the Edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the Edge computing system does not necessarily mean that such node or device operates in a client or agent/minion/follower role; rather, any of the nodes or devices in the Edge computing system refer to individual entities, nodes, or subsystems which include discrete or connected hardware or software configurations to facilitate or use the Edge cloud 510.

As such, the Edge cloud 510 is formed from network components and functional features operated by and within Edge gateway nodes, Edge aggregation nodes, or other Edge compute nodes among network layers 610-630. The Edge cloud 510 thus may be embodied as any type of network that provides Edge computing and/or storage resources which are proximately located to radio access network (RAN) capable endpoint devices (e.g., mobile computing devices, IoT devices, smart devices, etc.), which are discussed herein. In other words, the Edge cloud 510 may be envisioned as an “Edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

The network components of the Edge cloud 510 may be servers, multi-tenant servers, appliance computing devices, and/or any other type of computing devices. For example, the Edge cloud 510 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, Edge devices are devices presented in the network for a specific purpose (e.g., a traffic light), but may have processing and/or other capacities that may be utilized for other purposes. Such Edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. The Edge cloud 510 may also include one or more servers and/or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code, or scripts.

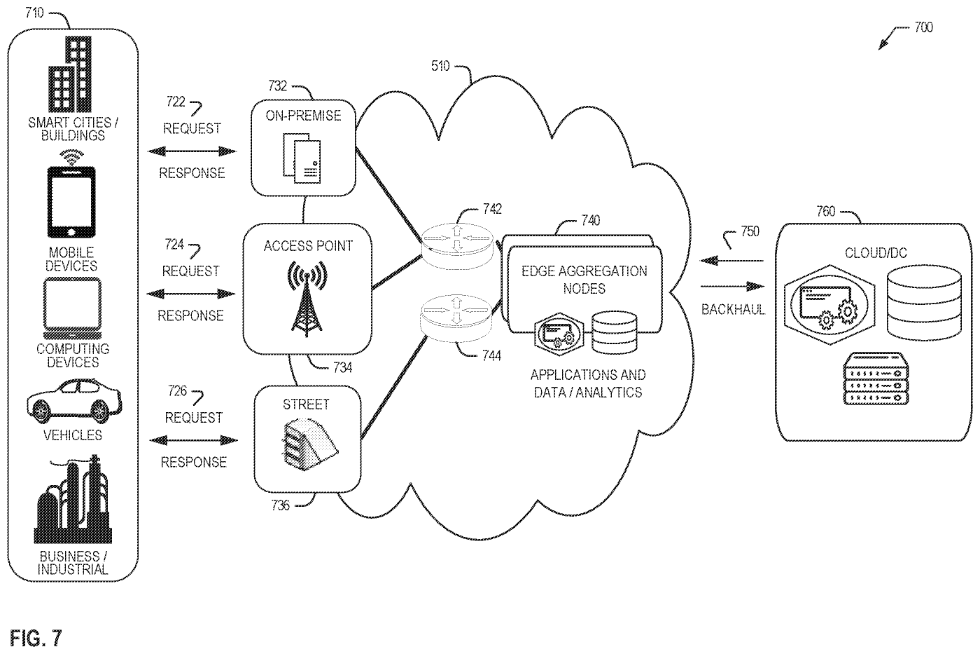

In FIG. 7, various client endpoints 710 (in the form of mobile devices, computers, autonomous vehicles, business computing equipment, industrial processing equipment) exchange requests and responses that are specific to the type of endpoint network aggregation. For instance, client endpoints 710 may obtain network access via a wired broadband network, by exchanging requests and responses 722 through an on-premises network system 732. Some client endpoints 710, such as mobile computing devices, may obtain network access via a wireless broadband network, by exchanging requests and responses 724 through an access point (e.g., cellular network tower) 734. Some client endpoints 710, such as autonomous vehicles may obtain network access for requests and responses 726 via a wireless vehicular network through a street-located network system 736. However, regardless of the type of network access, the TSP may deploy aggregation points 742, 744 within the Edge cloud 510 to aggregate traffic and requests. Thus, within the Edge cloud 510, the TSP may deploy various compute and storage resources, such as at Edge aggregation nodes 740, to provide requested content. The Edge aggregation nodes 740 and other systems of the Edge cloud 510 are connected to a cloud or data center 760, which uses a backhaul network 750 to fulfill higher-latency requests from a cloud/data center for websites, applications, database servers, etc. Additional or consolidated instances of the Edge aggregation nodes 740 and the aggregation points 742, 744, including those deployed on a single server framework, may also be present within the Edge cloud 510 or other areas of the TSP infrastructure.

Flowcharts representative of example machine-readable instructions, which may be executed by programmable circuitry to (e.g., instructions to cause programmable circuitry to) implement and/or instantiate the application layer-capable device 200 of FIG. 2 and/or representative of example operations which may be performed by programmable circuitry to implement and/or instantiate the application layer-capable device 200 of FIG. 2, are shown in FIGS. 8, 12, and/or 13. Additionally, flowcharts representative of example machine-readable instructions, which may be executed by programmable circuitry to implement and/or instantiate the feedback-capable device 300 of FIG. 3 and/or representative of example operations which may be performed by programmable circuitry to (e.g., instructions to cause programmable circuitry to) implement and/or instantiate the feedback-capable device 300 of FIG. 3, are shown in FIGS. 9, 10, and/or 11. The machine-readable instructions may be one or more executable programs or portion(s) of one or more executable programs for execution by programmable circuitry such as the programmable circuitry 1412 shown in the example programmable circuitry platform 1400 discussed below in connection with FIG. 14 and/or may be one or more function(s) or portion(s) of functions to be performed by the example programmable circuitry (e.g., an FPGA) discussed below in connection with FIGS. 15 and/or 16. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 8, 9, 10, 11, 12, and/or 13, many other methods of implementing the example application layer-capable device 200 of FIG. 2 and/or the feedback-capable device 300 of FIG. 3 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine-executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine-executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 8, 9, 10, 11, 12, and/or 13 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

FIG. 8 is a flowchart representative of example machine-readable instructions and/or example operations 800 that may be executed, instantiated, and/or performed by example programmable circuitry to implement the application layer-capable device 200 of FIG. 2 to control network congestion based on in-network computation delay. The example machine-readable instructions and/or the example operations 800 of FIG. 8 begin at block 802, at which the application execution circuitry 208 generates one or more application packets based on a workload executed by the application execution circuitry 208.

In the illustrated example of FIG. 8, at block 804, the application execution circuitry 208 assigns a first identifier to the one or more application packets where the first identifier is associated with a class of the workload. For example, at block 804, the application execution circuitry 08 includes a first identifier in the one or more application packets. At block 806, the operation scheduling circuitry 212 determines one or more operations according to which the one or more application packets are to be processed. At block 808, the operation to flow mapping circuitry 214 converts the one or more application packets into a first packet flow based on the one or more operations and/or a priority of the class of the workload.

In the illustrated example of FIG. 8, at block 810, the delay determination circuitry 222 identifies a second packet flow based on a second identifier included in packets of the second packet flow where the second identifier is associated with the class of the workload (e.g., a matching workload type, a same workload type, etc.). At block 812, the delay determination circuitry 222 predicts a delay associated with transmission of the first packet flow through a network based on a delay measurement of the second packet flow. At block 814, the delay determination circuitry 222 determines whether the delay satisfies a delay threshold. Based on (e.g., in response to) the delay determination circuitry 222 determining that the delay satisfies the delay threshold (block 814: YES), the machine-readable instructions and/or the operations 800 proceed to block 816. Based on (e.g., in response to) the delay determination circuitry 222 determining that the delay does not satisfy the delay threshold (block 814: NO), the machine-readable instructions and/or the operations 800 proceed to block 818.

In the illustrated example of FIG. 8, at block 816, the delay determination circuitry 222 sets a first ECN flag for packets of the first packet flow. At block 818, determines a first utilization of a queue of interface circuitry (e.g., the transmitter and/or receiver circuitry 232 of FIG. 2) by the second packet flow. At block 820, the queue analysis circuitry 224 predicts a second utilization of the queue by the first packet flow based on the first utilization. At block 822, the queue analysis circuitry 224 determines whether the predicted utilization satisfies a utilization threshold.

In the illustrated example of FIG. 8, based on (e.g., in response to) the queue analysis circuitry 224 determining that the second utilization satisfies the utilization threshold (block 822: YES), the machine-readable instructions and/or the operations 800 proceed to block 824. Based on (e.g., in response to) the queue analysis circuitry 224 determining that the second utilization does not satisfy the utilization threshold (block 822: NO), the machine-readable instructions and/or the operations 800 proceed to block 826. At block 824, the queue analysis circuitry 224 sets a second ECN flag for packets of the first packet flow.

In the illustrated example of FIG. 8, at block 826, the rate computation circuitry 226 determines a bitrate to be utilized to transmit the first packet flow to a device in the network based on the delay and the second utilization. At block 828, the pacing circuitry 228 divides the first packet flow into one or more segments based on a difference between the bitrate and a size of the first packet flow. In some examples, block 828 may be omitted from the machine-readable instructions and/or the operations 800. For example, if the size of the first packet flow is less than the bitrate, block 828 may be omitted from the machine-readable instructions and/or the operations 800.

In the illustrated example of FIG. 8, at block 830, the pacing circuitry 228 causes the interface circuitry to transmit a first packet of the first packet flow to the device at the bitrate. At block 832, the application execution circuitry 208 determines whether there is an additional application packet. Based on (e.g., in response to) the application execution circuitry 208 determining that there is an additional application packet (block 832: YES), the machine-readable instructions and/or the operations 800 return to block 804. Based on (e.g., in response to) the application execution circuitry 208 determining that there is not an additional application packet (block 832: NO), the machine-readable instructions and/or the operations 800 terminate.

FIG. 9 is a flowchart representative of example machine-readable instructions and/or example operations 900 that may be executed, instantiated, and/or performed by example programmable circuitry to implement the feedback-capable device 300 of FIG. 3 to perform in-network processing. The example machine-readable instructions and/or the example operations 900 of FIG. 9 begin at block 902, at which the receiver circuitry 302 receives a packet of a packet flow from a device, the packet including data associated with a workload. At block 904, the application processing circuitry 306 parses the packet to determine a workload type of the workload associated with the packet flow. For example, at block 904, the application processing circuitry 306 parses the packet to determine an ID (e.g., a class ID, a workload ID, an application ID, etc.) included in the packet.

In the illustrated example of FIG. 9, at block 906, the application processing circuitry 306 processes the data included with the packet based on the workload type. At block 908, the application processing circuitry 306 causes interface circuitry (e.g., is to cause interface circuitry (e.g., the transmitter circuitry 314)) to transmit a result of processing the data to the device. At block 910, the receiver circuitry 302 determines whether an additional packet has been received. Based on (e.g., in response to), the receiver circuitry 302 determining that an additional packet has been received (block 910: YES), the machine-readable instructions and/or the operations 900 return to block 904. Based on (e.g., in response to), the receiver circuitry 302 determining that an additional packet has not been received (block 910: NO), the machine-readable instructions and/or the operations 900 terminate.

FIG. 10 is a flowchart representative of example machine-readable instructions and/or example operations 1000 that may be executed, instantiated, and/or performed by example programmable circuitry to implement the feedback-capable device 300 of FIG. 3 to compute a bitrate to be utilized to transmit a packet flow based on in-network computation delay. The example machine-readable instructions and/or the example operations 1000 of FIG. 10 begin at block 1002, at which the rate computation circuitry 308 determines whether a current utilization of a queue of a first device satisfies (e.g., is greater than or equal to) a utilization threshold for the first device where the current utilization corresponds to a first packet flow associated with a workload. In the example of FIG. 10, the utilization threshold is an upper utilization threshold for the first packet flow that corresponds to an upper bound for a length of queue that is allocated to the first packet flow.

In the illustrated example of FIG. 10, based on (e.g., in response to) the rate computation circuitry 308 determining that the current utilization satisfies the utilization threshold (block 1002: YES), the machine-readable instructions and/or the operations 1000 proceed to block 1006. Based on (e.g., in response to) the rate computation circuitry 308 determining that the current utilization does not satisfy the utilization threshold (block 1002: NO), the machine-readable instructions and/or the operations 1000 proceed to block 1004. At block 1004, the rate computation circuitry 308 determines whether a current delay associated with processing data associated with the workload at the first device satisfies (e.g., is greater than) a delay threshold. For example, the delay threshold is an upper delay threshold that corresponds to an upper bound (e.g., an acceptable delay limit) for delay when processing the workload.

In the illustrated example of FIG. 10, based on (e.g., in response to) the rate computation circuitry 308 determining that the current delay satisfies the delay threshold (block 1004: YES), the machine-readable instructions and/or the operations 1000 proceed to block 1006. Based on (e.g., in response to) the rate computation circuitry 308 determining that the current delay does not satisfy the delay threshold (block 1004: NO), the machine-readable instructions and/or the operations 1000 proceed to block 1030. At block 1006, the rate computation circuitry 308 determines whether a current bitrate utilized to transmit the first packet flow satisfies (e.g., is greater than) an average of an upper bitrate threshold and a number of second packet flows to be transmitted by the first device

$$( e . g . , {R}_{Curr} > \frac{{R}_{Upper Threshold}}{{N}_{F l o w s}} ) .$$

In the illustrated example of FIG. 10, the upper bitrate threshold can correspond to a bandwidth of the first device. Based on (e.g., in response to) the rate computation circuitry 308 determining that the current bitrate satisfies the average (block 1006: YES), the machine-readable instructions and/or the operations 1000 proceed to block 1008. Based on (e.g., in response to) the rate computation circuitry 308 determining that the current bitrate does not satisfy the average (block 1006: NO), the machine-readable instructions and/or the operations 1000 proceed to block 1010. At block 1008, the rate computation circuitry 308 sets the current bitrate to a lower bitrate threshold for the first device.

In the illustrated example of FIG. 10, at block 1010, the rate computation circuitry 308 determines whether a first difference between the current utilization of the queue and a previous utilization of the queue satisfies (e.g., is greater than) a utilization growth threshold. For example, at block 1010, the rate computation circuitry 308 determines whether the utilization of the queue by the first packet flow is growing too quickly. In the example of FIG. 10, the utilization growth threshold can be any value between zero and the utilization threshold. Additionally, in the example of FIG. 10, the previous utilization corresponds to a utilization of the queue that was determined during a previous iteration of the machine-readable instructions and/or the operations 1000.

In the illustrated example of FIG. 10, based on (e.g., in response to) the rate computation circuitry 308 determining that the first difference between the current utilization of the queue and the previous utilization of the queue satisfies the utilization growth threshold (block 1010: YES), the machine-readable instructions and/or the operations 1000 proceed to block 1014. Based on (e.g., in response to) the rate computation circuitry 308 determining that the first difference between the current utilization of the queue and the previous utilization of the queue does not satisfy the utilization growth threshold (block 1010: NO), the machine-readable instructions and/or the operations 1000 proceed to block 1012. At block 1012, the rate computation circuitry 308 determines whether a second difference between the current delay and a previous delay satisfies (e.g., is greater than) a delay growth threshold where the previous delay is associated with processing data associated with the workload.

For example, at block 1012, the rate computation circuitry 308 determines whether the delay associated with processing data associated with the workload is growing too quickly. In the example of FIG. 10, the delay growth threshold can be any value between zero and the delay threshold. Additionally, in the example of FIG. 10, the previous delay corresponds to a delay associated with processing data associated with the workload that was determined during a previous iteration of the machine-readable instructions and/or the operations 1000.

In the illustrated example of FIG. 10, based on (e.g., in response to) the rate computation circuitry 308 determining that the second difference between the current delay and the previous delay satisfies the delay growth threshold (block 1012: YES), the machine-readable instructions and/or the operations 1000 proceed to block 1014. Based on (e.g., in response to) the rate computation circuitry 308 determining that the second difference between the current delay and the previous delay does not satisfy the delay growth threshold (block 1012: NO), the machine-readable instructions and/or the operations 1000 proceed to block 1016. At block 1014, the rate computation circuitry 308 decreases the current bitrate.

For example, at block 1014, the rate computation circuitry 308 sets the current bitrate to be the quotient of the previous bitrate divided by a decreasing parameter

$$( e . g . , {R}_{{Curr}_{t}} = \frac{{R}_{{Curr}_{t - 1}}}{m} ) .$$

In the example of FIG. 10, the previous bitrate corresponds to a bitrate that was determined during a previous iteration of the machine-readable instructions and/or the operations 1000. In the example of FIG. 10, the decreasing parameter is a configurable value. For example, the decreasing parameter is set to two. At block 1016, the rate computation circuitry 308 sets the current bitrate based on the first difference. For example, at block 1016, the rate computation circuitry 308 sets the bitrate to be equal to the difference between the current bitrate and the product of (a) the first difference and (b) the sum of a first control parameter and a second control parameter for the first device (e.g., R_{Curr}_{ₜ}=R_{Curr}_{ₜ₋₁}−[Q(t)−Q(t−1)]*[a+b]).

In the illustrated example of FIG. 10, at block 1018, the rate computation circuitry 308 determines whether the current bitrate satisfies (e.g., is greater than) the upper bitrate threshold for the first device. Based on (e.g., in response to) the rate computation circuitry 308 determining that the current bitrate satisfies the upper bitrate threshold (block 1018: YES), the machine-readable instructions and/or the operations 1000 proceed to block 1024. Based on (e.g., in response to) the rate computation circuitry 308 determining that the current bitrate does not satisfy the upper bitrate threshold (block 1018: NO), the machine-readable instructions and/or the operations 1000 proceed to block 1020. At block 1020, the rate computation circuitry 308 determines whether the current bitrate satisfies (e.g., is less than) the lower bitrate threshold for the first device.

In the illustrated example of FIG. 10, based on (e.g., in response to) the rate computation circuitry 308 determining that the current bitrate satisfies the lower bitrate threshold (block 1020: YES), the machine-readable instructions and/or the operations 1000 proceed to block 1022. Based on (e.g., in response to) the rate computation circuitry 308 determining that the current bitrate does not satisfy the lower bitrate threshold (block 1020: NO), the machine-readable instructions and/or the operations 1000 proceed to block 1026. At block 1022, the rate computation circuitry 308 sets the current bitrate equal to the lower bitrate threshold.

In the illustrated example of FIG. 10, at block 1024, based on (e.g., in response to) the rate computation circuitry 308 determining that the current bitrate satisfies (e.g., exceeds) the upper bitrate threshold, the rate computation circuitry 308 sets the current bitrate equal to the upper bitrate threshold. At block 1026, the rate computation circuitry 308 sets the current utilization of the queue of the first device by the first packet flow equal to the previous utilization of the queue. At block 1028, the feedback traffic generation circuitry 312 causes transmission of a packet to a second device to identify the current bitrate. For example, at block 1028, the feedback traffic generation circuitry 312 causes transmission of a CNP.

In the illustrated example of FIG. 10, at block 1030, the rate computation circuitry 308 determines whether to continue operating. For example, if a period after which the current bitrate is to be recomputed as expired or the rate computation circuitry 308 has received a trigger, then the rate computation circuitry 308 can determine to continue operating. Based on (e.g., in response to) the rate computation circuitry 308 determining to continue operating (block 1030: YES), the machine-readable instructions and/or the operations 1000 return to block 1002. Based on (e.g., in response to) the rate computation circuitry 308 determining not to continue operating (block 1030: NO), the machine-readable instructions and/or the operations 1000 terminate.

Although the machine-readable instructions and/or the operations 1000 are described with respect to the feedback-capable device 300 of FIG. 3, the machine-readable instructions and/or the operations 1000 are likewise applicable to the application layer-capable device 200 of FIG. 2. In some examples, the rate computation circuitry 226 of FIG. 2 may implement the machine-readable instructions and/or the operations 1000 of FIG. 10. For example, the rate computation circuitry 226 of FIG. 2 may implement the machine-readable instructions and/or the operations represented by blocks 1002, 1004, 1006, 1008, 1010, 1012, 1014, 1016, 1018, 1020, 1022, 1024, 1026, and/or 1030 of FIG. 10.

FIG. 11 is a flowchart representative of example machine-readable instructions and/or example operations 1100 that may be executed, instantiated, and/or performed by example programmable circuitry to implement the feedback-capable device 300 of FIG. 3 to compute control parameters of the feedback-capable device 300 based on in-network computation delay. The example machine-readable instructions and/or the example operations 1100 of FIG. 11 begin at block 1102, at which the rate computation circuitry 308 initializes a scaling variable. For example, the rate computation circuitry 308 initializes the scaling variable at a value of two.

In the illustrated example of FIG. 11, at block 1104, the rate computation circuitry 308 doubles a current value of the scaling variable. At block 1106, the rate computation circuitry 308 determines whether a current bitrate utilized by a first device to transmit a first packet flow satisfies (e.g., is less than) an upper bitrate threshold for the first device. Based on (e.g., in response to), the rate computation circuitry 308 determining that the current bitrate satisfies the upper bitrate threshold (block 1106: YES), the machine-readable instructions and/or the operations 1100 proceed to block 1108. Based on (e.g., in response to), the rate computation circuitry 308 determining that the current bitrate does not satisfy the upper bitrate threshold (block 1106: NO), the machine-readable instructions and/or the operations 1100 proceed to block 1112.

In the illustrated example of FIG. 11, at block 1108, the rate computation circuitry 308 determines whether a current delay associated with processing data associated with a workload at the first device satisfies (e.g., is less than) a delay threshold for the first device. Based on (e.g., in response to), the rate computation circuitry 308 determining that the current delay satisfies the delay threshold (block 1108: YES), the machine-readable instructions and/or the operations 1100 proceed to block 1110. Based on (e.g., in response to), the rate computation circuitry 308 determining that the current delay does not satisfy the delay threshold (block 1108: NO), the machine-readable instructions and/or the operations 1100 proceed to block 1112.

In the illustrated example of FIG. 11, at block 1110, the rate computation circuitry 308 determines whether a current value of the scaling variable satisfies (e.g., is less than) a scaling threshold for the first device. For example, the scaling threshold is 64 which corresponds to 64 bytes. Based on (e.g., in response to), the rate computation circuitry 308 determining that the current value of the scaling variable satisfies the scaling threshold (block 1110: YES), the machine-readable instructions and/or the operations 1100 return to block 1104. Based on (e.g., in response to), the rate computation circuitry 308 determining that the current value of the scaling variable does not satisfy the scaling threshold (block 1110: NO), the machine-readable instructions and/or the operations 1100 proceed to block 1112.

In the illustrated example of FIG. 11, at block 1112, the rate computation circuitry 308 sets a factor variable equal to half the current value of the scaling variable. At block 1114, the rate computation circuitry 308 determines a first control parameter for the first device based on the factor variable and a first parameter of the first device

$$( e . g . , a = \frac{{a}^{*}}{Factor} ) .$$

In the example of FIG. 11, the first parameter is a configurable value that varies based on the specification of the first device. For example, if the first device is a 40 gigabit per second (Gbps) network switch, the first parameter may be 0.3. Alternatively, if the first device is a 100 Gbps network switch, the first parameter may be 0.45.

In the illustrated example of FIG. 11, at block 1116, the rate computation circuitry 308 determines a second control parameter for the first device based on the factor variable and a second parameter of the first device

$$( e . g . , b = \frac{{b}^{*}}{Factor} ) .$$

In the example of FIG. 11, the second parameter is a configurable value that varies based on the specification of the first device. For example, if the first device is a 40 Gbps network switch, the second parameter may be 1.5. Alternatively, if the first device is a 100 Gbps network switch, the second parameter may be 2.25.

Although the machine-readable instructions and/or the operations 1100 are described with respect to the feedback-capable device 300 of FIG. 3, the machine-readable instructions and/or the operations 1100 are likewise applicable to the application layer-capable device 200 of FIG. 2. In some examples, the rate computation circuitry 226 of FIG. 2 may implement the machine-readable instructions and/or the operations 1100 of FIG. 11. For example, the rate computation circuitry 226 of FIG. 2 may implement the machine-readable instructions and/or the operations represented by blocks 1102, 1104, 1106, 1108, 1110, 1112, 1114, and/or 1116 of FIG. 11.

FIG. 12 is a flowchart representative of example machine-readable instructions and/or example operations 1200 that may be executed, instantiated, and/or performed by example programmable circuitry to implement the application layer-capable device 200 of FIG. 2 to process a congestion notification packet. The example machine-readable instructions and/or the example operations 1200 of FIG. 12 begin at block 1202, at which the rate computation circuitry 226 accesses, at a first device (e.g., the application layer-capable device 200), a congestion notification packet from a second congested device where the congestion notification packet is associated with a packet flow.

In the illustrated example of FIG. 12, at block 1204, the rate computation circuitry 226 determines whether the second congested device matches a current congested device associated with a rate limiter implemented at the first device where the current congested device is associated with the packet flow. Based on (e.g., in response to) the rate computation circuitry 226 determining that the second congested device matches the current congested device (block 1204: YES), the machine-readable instructions and/or the operations 1200 proceed to block 1208. Based on (e.g., in response to) the rate computation circuitry 226 determining that the second congested device does not match the current congested device (block 1204: NO), the machine-readable instructions and/or the operations 1200 proceed to block 1206.

In the illustrated example of FIG. 12, at block 1206, the rate computation circuitry 226 determines whether a received bitrate identified in the congestion notification packet satisfies (e.g., is less than or equal to) a current bitrate utilized by the first device to transmit the packet flow. Based on (e.g., in response to) the rate computation circuitry 226 determining that the received bitrate satisfies the current bitrate (block 1206: YES), the machine-readable instructions and/or the operations 1200 proceed to block 1208. Based on (e.g., in response to) the rate computation circuitry 226 determining that the received bitrate does not satisfy the current bitrate (block 1206: NO), the machine-readable instructions and/or the operations 1200 proceed to block 1214.

In the illustrated example of FIG. 12, at block 1208, the rate computation circuitry 226 sets the current bitrate to the received bitrate. At block 1210, the rate computation circuitry 226 sets the current congested device associated with the packet flow to the second congested device. At block 1212, the rate computation circuitry 226 stops a bitrate recovery timer (e.g., counter) for the packet flow.

In the illustrated example of FIG. 12, at block 1214, the rate computation circuitry 226 determines whether to continue monitoring for a congestion notification packet. Based on (e.g., in response to) the rate computation circuitry 226 determining to continue monitoring for a congestion notification packet (block 1214: YES), the machine-readable instructions and/or the operations 1200 return to block 1202. Based on (e.g., in response to) the rate computation circuitry 226 determining not to continue monitoring for a congestion notification packet (block 1214: NO), the machine-readable instructions and/or the operations 1200 terminate.

Although the machine-readable instructions and/or the operations 1200 are described with respect to the application layer-capable device 200 of FIG. 2, the machine-readable instructions and/or the operations 1200 are likewise applicable to the feedback-capable device 300 of FIG. 3. In some examples, the rate computation circuitry 308 of FIG. 3 may implement the machine-readable instructions and/or the operations 1200 of FIG. 12. For example, the rate computation circuitry 308 of FIG. 3 may implement the machine-readable instructions and/or the operations represented by blocks 1202, 1204, 1206, 1208, 1210, 1212, and/or 1214 of FIG. 12.

FIG. 13 is a flowchart representative of example machine-readable instructions and/or example operations 1300 that may be executed, instantiated, and/or performed by example programmable circuitry to implement the application layer-capable device 200 of FIG. 2 to perform bitrate recover after network congestion has subsided. The example machine-readable instructions and/or the example operations 1300 of FIG. 13 begin at block 1302, at which the rate computation circuitry 226 initializes a bitrate recovery timer (e.g., counter) for a packet flow.

In the illustrated example of FIG. 13, at block 1304, the rate computation circuitry 226 monitors the bitrate recovery timer. At block 1306, the rate computation circuitry 226 determines whether the bitrate recovery timer has expired (e.g., whether the counter has reached zero, whether the counter has reached an upper threshold, etc.). Based on (e.g., in response to) the rate computation circuitry 226 determining that the bitrate recovery timer has expired (block 1306: YES), the machine-readable instructions and/or the operations 1300 proceed to block 1308. Based on (e.g., in response to) the rate computation circuitry 226 determining that the bitrate recovery timer has not expired (block 1306: NO), the machine-readable instructions and/or the operations 1300 return to block 1304.

In the illustrated example of FIG. 13, at block 1308, the rate computation circuitry 226 determines whether a current bitrate utilized by a device (e.g., the application layer-capable device 200) to transmit the packet flow satisfies (e.g., exceeds) an upper bitrate threshold for the device. Based on (e.g., in response to) the rate computation circuitry 226 determining that the current bitrate satisfies the upper bitrate threshold (block 1308: YES), the machine-readable instructions and/or the operations 1300 proceed to block 1310. Based on (e.g., in response to) the rate computation circuitry 226 determining that the current bitrate satisfies the upper bitrate threshold (block 1308: NO), the machine-readable instructions and/or the operations 1300 proceed to block 1314.

In the illustrated example of FIG. 13, at block 1310, the rate computation circuitry 226 determines whether a utilization of a queue of the device by the packet flow satisfies (e.g., exceeds) a utilization threshold for the device. Based on (e.g., in response to) the rate computation circuitry 226 determining that the utilization satisfies the utilization threshold (block 1310: YES), the machine-readable instructions and/or the operations 1300 proceed to block 1312. Based on (e.g., in response to) the rate computation circuitry 226 determining that the utilization does not satisfy the utilization threshold (block 1310: NO), the machine-readable instructions and/or the operations 1300 proceed to block 1316. At block 1312, the rate computation circuitry 226 removes a rate limited for the packet flow.

In the illustrated example of FIG. 13, at block 1314, the rate computation circuitry 226 doubles the current bitrate. At block 1316, the rate computation circuitry 226 determines whether to continue operating. Based on (e.g., in response to) the rate computation circuitry 226 determining to continue operating (block 1316: YES), the machine-readable instructions and/or the operations 1300 return to block 1302. Based on (e.g., in response to) the rate computation circuitry 226 determining not to continue operating (block 1316: NO), the machine-readable instructions and/or the operations 1300 terminate.

Although the machine-readable instructions and/or the operations 1300 are described with respect to the application layer-capable device 200 of FIG. 2, the machine-readable instructions and/or the operations 1300 are likewise applicable to the feedback-capable device 300 of FIG. 3. In some examples, the rate computation circuitry 308 of FIG. 3 may implement the machine-readable instructions and/or the operations 1300 of FIG. 13. For example, the rate computation circuitry 308 of FIG. 3 may implement the machine-readable instructions and/or the operations represented by blocks 1302, 1304, 1306, 1308, 1310, 1312, 1314, and/or 1316 of FIG. 13.

FIG. 14 is a block diagram of an example programmable circuitry platform 1400 structured to execute and/or instantiate the example machine-readable instructions and/or the example operations of FIGS. 8, 9, 10, 11, 12, and/or 13 to implement the application layer-capable device 200 of FIG. 2 and/or the feedback-capable device 300 of FIG. 3. The programmable circuitry platform 1400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1400 of the illustrated example includes programmable circuitry 1412. The programmable circuitry 1412 of the illustrated example is hardware. For example, the programmable circuitry 1412 can be implemented by one or more integrated circuits, logic circuits, FPGAs, microprocessors, CPUs, GPUs, DSPs, and/or microcontrollers from any desired family or manufacturer. The programmable circuitry 1412 may be implemented by one or more semiconductor based (e.g., silicon based) devices. In this example, the programmable circuitry 1412 implements the example application execution circuitry 208, the example operation scheduling circuitry 212, the example operation to flow mapping circuitry 214, the example flow to operation mapping circuitry 216, the example delay determination circuitry 222, the example queue analysis circuitry 224, the example rate computation circuitry 226, the example pacing circuitry 228, and/or, more generally, the example congestion control circuitry 218, the example application processing circuitry 306, the example rate computation circuitry 308, and the example feedback traffic generation circuitry 312.

The programmable circuitry 1412 of the illustrated example includes a local memory 1413 (e.g., a cache, registers, etc.). The programmable circuitry 1412 of the illustrated example is in communication with main memory 1414, 1416, which includes a volatile memory 1414 and a non-volatile memory 1416, by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. In this example, the volatile memory 1414 implements the example command and completion queues 210, the example NIC queues 230, the example packet flow queue 304, and the example packet flow metadata datastore 310. The non-volatile memory 1416 may be implemented by flash memory and/or any other desired type of memory device. Access to the main memory 1414, 1416 of the illustrated example is controlled by a memory controller 1417. In some examples, the memory controller 1417 may be implemented by one or more integrated circuits, logic circuits, microcontrollers from any desired family or manufacturer, or any other type of circuitry to manage the flow of data going to and from the main memory 1414, 1416.

The programmable circuitry platform 1400 of the illustrated example also includes interface circuitry 1420. The interface circuitry 1420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1422 are connected to the interface circuitry 1420. The input device(s) 1422 permit(s) a user (e.g., a human user, a machine user, etc.) to enter data and/or commands into the programmable circuitry 1412. The input device(s) 1422 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1424 are also connected to the interface circuitry 1420 of the illustrated example. The output device(s) 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc. In this example, the interface circuitry 1420 implements the example transmitter and/or receiver circuitry 232, the example receiver circuitry 302, and the example transmitter circuitry 314.

The programmable circuitry platform 1400 of the illustrated example also includes one or more mass storage discs or devices 1428 to store firmware, software, and/or data. Examples of such mass storage discs or devices 1428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1432, which may be implemented by the machine-readable instructions of FIGS. 8, 9, 10, 11, 12, and/or 13, may be stored in the mass storage device 1428, in the volatile memory 1414, in the non-volatile memory 1416, and/or on at least one non-transitory computer-readable storage medium such as a CD or DVD which may be removable.

FIG. 15 is a block diagram of an example implementation of the programmable circuitry 1412 of FIG. 14. In this example, the programmable circuitry 1412 of FIG. 14 is implemented by a microprocessor 1500. For example, the microprocessor 1500 may be a general-purpose microprocessor (e.g., general-purpose microprocessor circuitry). The microprocessor 1500 executes some or all of the machine-readable instructions of the flowcharts of FIGS. 8, 9, 10, 11, 12, and/or 13 to effectively instantiate the circuitry of FIGS. 2 and/or 3 as logic circuits to perform operations corresponding to those machine-readable instructions. In some such examples, the circuitry of FIGS. 2 and/or 3 is instantiated by the hardware circuits of the microprocessor 1500 in combination with the machine--readable instructions. For example, the microprocessor 1500 may be implemented by multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine-readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine-readable instructions and/or operations represented by the flowcharts of FIGS. 8, 9, 10, 11, 12, and/or 13.

The cores 1502 may communicate by a first example bus 1504. In some examples, the first bus 1504 may be implemented by a communication bus to effectuate communication associated with one(s) of the cores 1502. For example, the first bus 1504 may be implemented by at least one of an Inter-Integrated Circuit (I2C) bus, a Serial Peripheral Interface (SPI) bus, a PCI bus, or a PCIe bus. Additionally or alternatively, the first bus 1504 may be implemented by any other type of computing or electrical bus. The cores 1502 may obtain data, instructions, and/or signals from one or more external devices by example interface circuitry 1506. The cores 1502 may output data, instructions, and/or signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2 cache)) for high-speed access to data and/or instructions. Data and/or instructions may be transferred (e.g., shared) by writing to and/or reading from the shared memory 1510. The local memory 1520 of each of the cores 1502 and the shared memory 1510 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry (sometimes referred to as an ALU) 1516, a plurality of registers 1518, the local memory 1520, and a second example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic and/or logic operations on the data within the corresponding core 1502. The AL circuitry 1516 of some examples performs integer-based operations. In other examples, the AL circuitry 1516 also performs floating-point operations. In yet other examples, the AL circuitry 1516 may include first AL circuitry that performs integer-based operations and second AL circuitry that performs floating-point operations. In some examples, the AL circuitry 1516 may be referred to as an Arithmetic Logic Unit (ALU).

The registers 1518 are semiconductor-based structures to store data and/or instructions such as results of one or more of the operations performed by the AL circuitry 1516 of the corresponding core 1502. For example, the registers 1518 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure, such as by being distributed throughout the core 1502 to shorten access time. The second bus 1522 may be implemented by at least one of an I2C bus, a SPI bus, a PCI bus, or a PCIe bus.

Each core 1502 and/or, more generally, the microprocessor 1500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1500 is a semiconductor device fabricated to include many transistors interconnected to implement the structures described above in one or more integrated circuits (ICs) contained in one or more packages.

The microprocessor 1500 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1500, in the same chip package as the microprocessor 1500 and/or in one or more separate packages from the microprocessor 1500.

FIG. 16 is a block diagram of another example implementation of the programmable circuitry 1412 of FIG. 14. In this example, the programmable circuitry 1412 is implemented by FPGA circuitry 1600. For example, the FPGA circuitry 1600 may be implemented by an FPGA. The FPGA circuitry 1600 can be used, for example, to perform operations that could otherwise be performed by the example microprocessor 1500 of FIG. 15 executing corresponding machine-readable instructions. However, once configured, the FPGA circuitry 1600 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1500 of FIG. 15 described above (which is a general purpose device that may be programmed to execute some or all of the machine-readable instructions represented by the flowchart(s) of FIGS. 8, 9, 10, 11, 12, and/or 13 but whose interconnections and logic circuitry are fixed once fabricated), the FPGA circuitry 1600 of the example of FIG. 16 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 8, 9, 10, 11, 12, and/or 13. In particular, the FPGA circuitry 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 8, 9, 10, 11, 12, and/or 13. As such, the FPGA circuitry 1600 may be configured and/or structured to effectively instantiate some or all of the operations/functions corresponding to the machine-readable instructions of the flowchart(s) of FIGS. 8, 9, 10, 11, 12, and/or 13 as dedicated logic circuits to perform the operations/functions corresponding to those software instructions in a dedicated manner analogous to an ASIC. Therefore, the FPGA circuitry 1600 may perform the operations/functions corresponding to the some or all of the machine-readable instructions of FIGS. 8, 9, 10, 11, 12, and/or 13 faster than the general-purpose microprocessor can execute the same.

In the example of FIG. 16, the FPGA circuitry 1600 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

The FPGA circuitry 1600 of FIG. 16, includes example input/output (I/0) circuitry 1602 to obtain and/or output data to/from example configuration circuitry 1604 and/or external hardware 1606. For example, the configuration circuitry 1604 may be implemented by interface circuitry that may obtain a binary file, which may be implemented by a bit stream, data, and/or machine-readable instructions, to configure the FPGA circuitry 1600, or portion(s) thereof. In some such examples, the configuration circuitry 1604 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1606 may be implemented by external hardware circuitry. For example, the external hardware 1606 may be implemented by the microprocessor 1500 of FIG. 15.

The FPGA circuitry 1600 also includes an array of example logic gate circuitry 1608, a plurality of example configurable interconnections 1610, and example storage circuitry 1612. The logic gate circuitry 1608 and the configurable interconnections 1610 are configurable to instantiate one or more operations/functions that may correspond to at least some of the machine-readable instructions of FIGS. 8, 9, 10, 11, 12, and/or 13 and/or other desired operations. The logic gate circuitry 1608 shown in FIG. 16 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1608 to enable configuration of the electrical structures and/or the logic gates to form circuits to perform desired operations/functions. The logic gate circuitry 1608 may include other electrical structures such as look-up tables (LUTs), registers (e.g., flip-flops or latches), multiplexers, etc.

The configurable interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example dedicated operations circuitry 1614. In this example, the dedicated operations circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 and/or an example DSP 1622. Other general purpose programmable circuitry 1618 may additionally or alternatively be present such as a GPU, an XPU, etc., that can be programmed to perform other operations.

Although FIGS. 15 and 16 illustrate two example implementations of the programmable circuitry 1412 of FIG. 14, many other approaches are contemplated. For example, FPGA circuitry may include an on-board CPU, such as one or more of the example CPU 1620 of FIG. 16. Therefore, the programmable circuitry 1412 of FIG. 14 may additionally be implemented by combining at least the example microprocessor 1500 of FIG. 15 and the example FPGA circuitry 1600 of FIG. 16. In some such hybrid examples, one or more cores 1502 of FIG. 15 may execute a first portion of the machine-readable instructions represented by the flowchart(s) of FIGS. 8, 9, 10, 11, 12, and/or 13 to perform first operation(s)/function(s), the FPGA circuitry 1600 of FIG. 16 may be configured and/or structured to perform second operation(s)/function(s) corresponding to a second portion of the machine-readable instructions represented by the flowcharts of FIGS. 8, 9, 10, 11, 12, and/or 13, and/or an ASIC may be configured and/or structured to perform third operation(s)/function(s) corresponding to a third portion of the machine-readable instructions represented by the flowcharts of FIGS. 8, 9, 10, 11, 12, and/or 13.

It should be understood that some or all of the circuitry of FIGS. 2 and/or 3 may, thus, be instantiated at the same or different times. For example, same and/or different portion(s) of the microprocessor 1500 of FIG. 15 may be programmed to execute portion(s) of machine-readable instructions at the same and/or different times. In some examples, same and/or different portion(s) of the FPGA circuitry 1600 of FIG. 16 may be configured and/or structured to perform operations/functions corresponding to portion(s) of machine-readable instructions at the same and/or different times.

In some examples, some or all of the circuitry of FIGS. 2 and/or 3 may be instantiated, for example, in one or more threads executing concurrently and/or in series. For example, the microprocessor 1500 of FIG. 15 may execute machine-readable instructions in one or more threads executing concurrently and/or in series. In some examples, the FPGA circuitry 1600 of FIG. 16 may be configured and/or structured to carry out operations/functions concurrently and/or in series. Moreover, in some examples, some or all of the circuitry of FIGS. 2 and/or 3 may be implemented within one or more virtual machines and/or containers executing on the microprocessor 1500 of FIG. 15.

In some examples, the programmable circuitry 1412 of FIG. 14 may be in one or more packages. For example, the microprocessor 1500 of FIG. 15 and/or the FPGA circuitry 1600 of FIG. 16 may be in one or more packages. In some examples, an XPU may be implemented by the programmable circuitry 1412 of FIG. 14, which may be in one or more packages. For example, the XPU may include a CPU (e.g., the microprocessor 1500 of FIG. 15, the CPU 1620 of FIG. 16, etc.) in one package, a DSP (e.g., the DSP 1622 of FIG. 16) in another package, a GPU in yet another package, and an FPGA (e.g., the FPGA circuitry 1600 of FIG. 16) in still yet another package.

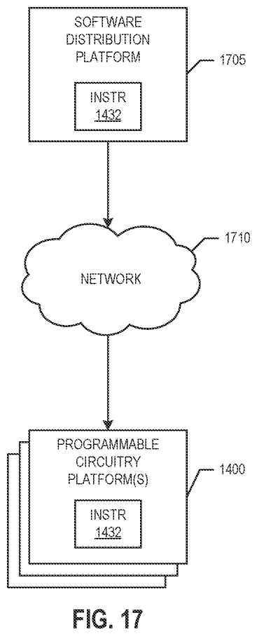

A block diagram illustrating an example software distribution platform 1705 to distribute software such as the example machine-readable instructions 1432 of FIG. 14 to other hardware devices (e.g., hardware devices owned and/or operated by third parties from the owner and/or operator of the software distribution platform) is illustrated in FIG. 17. The example software distribution platform 1705 may be implemented by any computer server, data facility, cloud service, etc., capable of storing and transmitting software to other computing devices. The third parties may be customers of the entity owning and/or operating the software distribution platform 1705. For example, the entity that owns and/or operates the software distribution platform 1705 may be a developer, a seller, and/or a licensor of software such as the example machine-readable instructions 1432 of FIG. 14. The third parties may be consumers, users, retailers, OEMs, etc., who purchase and/or license the software for use and/or re-sale and/or sub-licensing. In the illustrated example, the software distribution platform 1705 includes one or more servers and one or more storage devices. The storage devices store the machine-readable instructions 1432, which may correspond to the example machine-readable instructions of FIGS. 8, 9, 10, 11, 12, and/or 13, as described above. The one or more servers of the example software distribution platform 1705 are in communication with an example network 1710, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1432 from the software distribution platform 1705. For example, the software, which may correspond to the example machine-readable instructions of FIGS. 8, 9, 10, 11, 12, and/or 13, may be downloaded to the example programmable circuitry platform 1400, which is to execute the machine-readable instructions 1432 to implement the application layer-capable device 200 of FIG. 2 and/or the feedback-capable device 300 of FIG. 3. In some examples, one or more servers of the software distribution platform 1705 periodically offer, transmit, and/or force updates to the software (e.g., the example machine-readable instructions 1432 of FIG. 14) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed for in-network computation and control of network congestion based on in-network computation delays. For example, disclosed systems, methods, apparatus, and articles of manufacture provide transport layer protocols to enable scalable in-network computing (INC) with a variety of hardware including IPUs, DPUs, EPUs, FPGAs, ASICs, end-host device CPUs and/or XPUs, programmable switches, and middleboxes. Additionally, examples disclosed herein improve network multiplexing gain, improve packet flow fairness, increase link utilization, and improve multi-feedback handling. As such, examples disclosed herein reduce flow completion time (FCT) reduction, improve reliability, and improve stability via rapid convergence of packet flows.

Additionally, disclosed systems, apparatus, articles of manufacture, and methods improve the efficiency of using a computing device by improving network throughput via dynamic bitrate control at EH devices and/or IN devices. For example, computing performed at intermediate network devices contributes to end-to-end total delay. By compensating for delays resulting from in-network computing, examples disclosed herein prevent premature triggering of congestion control techniques. Furthermore, disclosed methods, apparatus, and articles of manufacture include application-specific context information (e.g., indicating whether to perform in-network computing with QoS parameters) in packet headers. Examples disclosed herein also generate accurate feedback (e.g., rate, queue size, delay) at congestion points in a network to help EH devices pinpoint potential causes of congestion and take appropriate action to alleviate congestion. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture for in-network computation and control of network congestion based on in-network computation delays are disclosed herein. Further examples and combinations thereof include the following:

Example 1 includes a device to be deployed in a network, the device comprising interface circuitry to access a packet including a header having (1) a destination address field to identify a first network address of a destination device capable of performing an action and (2) a workload class field to identify a workload class associated with the action, machine-readable instructions, programmable circuitry to utilize the machine-readable instructions to perform the action at the device based on the workload class field, the device having a second network address that is different than the first network address, modify an indicator field of the packet to indicate that the action has been performed, and cause the interface circuitry to forward the packet with the modified indicator field toward the destination device.

Example 2 includes the device of example 1, wherein the action includes an in-network compute primitive, the in-network compute primitive including at least one of a vector summation operation, a count operation, a cache operation, a store operation, a get operation, or a hash table operation.

Example 3 includes the device of any of examples 1 or 2, wherein the packet is a first packet, and the programmable circuitry is to cause the interface circuitry to transmit a second packet toward a source device of the packet, the second packet to identify at least one in-network compute primitive ability of the programmable circuitry.

Example 4 includes the device of any of examples 1, 2, or 3, wherein the packet is to be transmitted along a communication path from a source device to the destination device, and the programmable circuitry is to determine a level of congestion at another network device in the communication path, and determine to perform the action at the device based on the level of congestion.

Example 5 includes the device of example 4, wherein the programmable circuitry is to determine the level of congestion based on at least one of a congestion notification field, a delay level field, a queue state field, or a fair rate field, in the header of the packet.

Example 6 includes the device of any of examples 4 or 5, wherein the programmable circuitry is to perform the action at the device during a delay introduced by the level of congestion.

Example 7 includes the device of any of examples 1, 2, 3, 4, 5, or 6, wherein the packet is a first packet, the action is a first action, and the first packet is to be transmitted along a communication path from a source device to the destination device, and the programmable circuitry is to determine a level of congestion at a subsequent device in the communication path based on a feedback packet from the subsequent device, the feedback packet including at least one of a bitrate to be utilized by the subsequent device to transmit a second packet, a utilization of a queue at the subsequent device by the second packet, or a processing delay associated with performing a second action associated with the second packet at the subsequent device instead of the destination device, and determine to perform the action at the device based on the level of congestion at the subsequent device.

Example 8 includes the device of example 7, wherein the programmable circuitry is to perform the action at the device during a delay introduced by the level of congestion at the subsequent device.

Example 9 includes the device of any of examples 1, 2, 3, 4, 5, 6, 7, or 8, wherein the action is to be performed based on a payload of the packet, the payload is associated with an application, and the programmable circuitry is to modify the payload before the packet is forwarded toward the destination device.

Example 10 includes the device of any of examples 1, 2, 3, 4, 5, 6, 7, 8, or 9, wherein the packet is a first packet, the programmable circuitry is to determine a bitrate to be utilized to transmit the first packet towards the destination device, the bitrate based on a delay associated with performance of the action at the device, and the interface circuitry is to transmit a second packet to identify the bitrate toward at least one of a source device of the packet or the destination device.

Example 11 includes a source device comprising machine-readable instructions, programmable circuitry to utilize the machine-readable instructions to generate a packet including a header having (1) a destination address field to identify a network address of a destination device, and (2) a workload class field to identify a workload class associated with an action capable of being performed by the destination device, the workload class to be accessed by an intervening device along a communication path between the source device and the destination device, the intervening device to perform the action instead of the destination device, and interface circuitry to transmit the packet to the intervening device.

Example 12 includes the source device of example 11, wherein the packet is a first packet, and the programmable circuitry is to based on a second packet from the intervening device, determine at least one in-network compute primitive that can be performed by the intervening device, and select the communication path of the packet based on the at least one in-network compute primitive and the workload class.

Example 13 includes the source device of example 12, wherein the at least one in-network compute primitive is identified in the second packet.

Example 14 includes the source device of any of examples 12 or 13, wherein the at least one in-network compute primitive includes at least one of a vector summation operation, a count operation, a cache operation, a store operation, a get operation, or a hash table operation.

Example 15 includes the source device of any of examples 11, 12, 13, or 14, wherein the programmable circuitry is to populate at least one of a congestion notification field, a delay level field, a queue state field, or a fair rate field in the header of the packet before the packet is transmitted to the intervening device.

Example 16 includes the source device of any of examples 11, 12, 13, 14, or 15, wherein the packet is a first packet, the action is a first action, and the programmable circuitry is to access a feedback packet from the intervening device, the feedback packet including at least one of a first bitrate to be utilized by the intervening device to transmit a second packet, a utilization of a queue at the intervening device by the second packet, or a processing delay associated with performing a second action associated with the second packet at the intervening device instead of the destination device, and cause the interface circuitry to transmit the first packet to the intervening device at a second bitrate based on the feedback packet.

Example 17 includes the source device of any of examples 11, 12, 13, 14, 15, or 16, wherein the packet is a first packet, the interface circuitry is associated with a queue, and the programmable circuitry is to cause the interface circuitry to transmit the first packet to the intervening device at a bitrate based on a predicted delay and a utilization of the queue, the predicted delay based on a delay measurement of a second packet.

Example 18 includes the source device of any of examples 11, 12, 13, 14, 15, 16, or 17, wherein the header includes the workload class field and one or more second fields different than the workload class field, the one or more second fields including one or more of a version field, an internet header length field, a packet length field, a packet identifier field, a packet fragmentation flag field, a packet fragmentation offset field, a time to live field, a header checksum field, a source address field, the destination address field, a time stamp field, a retransmission field, or an acknowledgement field.

Example 19 includes a device to be deployed in a network, the device comprising machine-readable instructions, programmable circuitry to utilize the machine-readable instructions to parse a first packet from a source device, the first packet addressed to a destination device in the network, the first packet including a payload and a header, the header including a workload class field and one or more second fields different than the workload class field, the workload class field to indicate a workload class to be used to process the payload of the first packet, the one or more second fields including one or more of a version field, an internet header length field, a packet length field, a packet identifier field, a packet fragmentation flag field, a packet fragmentation offset field, a time to live field, a header checksum field, a source address field, a destination address field, a time stamp field, a retransmission field, or an acknowledgement field, prior to the first packet reaching the destination device, perform an operation on the payload that is not associated with routing of the first packet, the operation to produce an output, and interface circuitry to forward a second packet corresponding to the output to the destination device.

Example 20 includes the device of example 19, wherein the programmable circuitry is to determine a bitrate to be utilized to transmit the first packet towards the destination device, the bitrate based on a delay associated with performance of the operation at the device, and the interface circuitry is to transmit a third packet to identify the bitrate toward at least one of the source device of the first packet or the destination device.

Example 21 includes the device of any of examples 19 or 20, wherein the workload class field is located between the internet header length field and the packet length field.

Example 22 includes an in-network device to be deployed in a network, the in-network device comprising machine-readable instructions, programmable circuitry to utilize the machine-readable instructions to parse a packet to identify a header field of the packet, the packet from a first device in the network, and process a payload included with the packet at the in-network device based on the header field, and interface circuitry to transmit a result of processing the payload to at least one of the first device or a second device.

Example 23 includes the in-network device of example 22, wherein the packet is a first packet, the programmable circuitry is to determine a bitrate to be utilized to transmit a second packet including the result, the bitrate based on a delay associated with the processing of the payload at the in-network device, and the interface circuitry is to transmit a third packet to identify the bitrate to at least one of the first device or the second device.

Example 24 includes the in-network device of any of examples 22 or 23, wherein the programmable circuitry is to determine whether a delay associated with the processing of the payload at the in-network device satisfies a delay threshold.

Example 25 includes the in-network device of example 24, wherein the packet is a first packet, and the programmable circuitry is to, based on the delay satisfying the delay threshold, determine whether a bitrate currently utilized to transmit a second packet including the result satisfies an average of an upper bitrate threshold for the in-network device and a number of third packets to be transmitted by the in-network device, the first packet associated with a first workload, the third packets associated with respective second workloads.

Example 26 includes the in-network device of example 25, wherein the delay is a first delay, the bitrate is a first bitrate, the delay threshold is a first delay threshold, and the programmable circuitry is to, based on the first bitrate not satisfying the average, set a second bitrate to be utilized to transmit the second packet based on whether a difference between the first delay and a second delay satisfies a second delay threshold.

Example 27 includes the in-network device of any of examples 22, 23, 24, 25, or 26, wherein the packet is a first packet, the interface circuitry is associated with a queue, and the programmable circuitry is to set a bitrate to be utilized to transmit a second packet including the result based on a delay associated with the processing of the payload at the in-network device and a utilization of the queue.

Example 28 includes the in-network device of any of examples 22, 23, 24, 25, 26, or 27, wherein the payload is a first payload, the packet is a first packet, and the programmable circuitry is to decrease a bitrate to be utilized by the in-network device to transmit a third packet based on a first delay associated with the processing of the first payload at the in-network device being greater than a second delay associated with processing of a second payload at the in-network device, the first packet and the third packet associated with a same workload type.

Example 29 includes the in-network device of any of examples 22, 23, 24, 25, 26, 27, or 28, wherein the packet is a first packet, and the interface circuitry is to transmit a second packet to identify (a) a bitrate to be utilized to transmit a third packet including the result and (b) at least one of a delay associated with the processing of the payload at the in-network device, a utilization of a queue of the interface circuitry, the utilization associated with the third packet, a first identifier of a third device from which the first packet originated, or a second identifier of a fourth device at which the third packet is to terminate.

Example 30 includes the in-network device of any of examples 22, 23, 24, 25, 26, 27, 28, or 29, wherein the header field is a first header field, and the packet includes second header fields, the second header fields related to a protocol for communication of the packet.

Example 31 includes the in-network device of any of examples 22, 23, 24, 25, 26, 27, 28, 29, or 30, wherein the payload includes first payload data, and the programmable circuitry is to process the first payload data to generate second payload data, the second payload data corresponding to the result of processing the payload, and replace the first payload data of the payload with the second payload data.

Example 32 includes the in-network device of any of examples 22, 23, 24, 25, 26, 27, 28, 29, 30, or 31, wherein the header field identifies a workload type associated with the payload, and the programmable circuitry is to trigger a protocol corresponding to the workload type.

Example 33 includes the in-network device of any of examples 22, 23, 24, 25, 26, 27, 28, 29, 30, 31, or 32, wherein the header field identifies a workload type associated with the payload, and the workload type corresponds to at least one of a compression workload, an encryption workload, a scatter/gather workload, a load balancing workload, a network address translation workload, a domain name system server workload, a caching workload, a data reduction workload, or a data aggregation workload.

Example 34 includes a non-transitory machine-readable storage medium comprising instructions to cause programmable circuitry of an in-network device to at least parse a packet to identify a header field of the packet, the packet from a first device in a network, process a payload included with the packet at the in-network device based on the header field, and cause interface circuitry of the in-network device to transmit a result of processing the payload to at least one of the first device or a second device.

Example 35 includes the non-transitory machine-readable storage medium of example 34, wherein the packet is a first packet, and the instructions cause the programmable circuitry to determine a bitrate to be utilized to transmit a second packet including the result, the bitrate based on a delay associated with the processing of the payload at the in-network device, and cause the interface circuitry to transmit a third packet to identify the bitrate to at least one of the first device or the second device.

Example 36 includes the non-transitory machine-readable storage medium of any of examples 34 or 35, wherein the instructions cause the programmable circuitry to determine whether a delay associated with the processing of the payload at the in-network device satisfies a delay threshold.

Example 37 includes the non-transitory machine-readable storage medium of example 36, wherein the packet is a first packet, and the instructions cause the programmable circuitry to, based on the delay satisfying the delay threshold, determine whether a bitrate currently utilized to transmit a second packet including the result satisfies an average of an upper bitrate threshold for the in-network device and a number of third packets to be transmitted by the in-network device, the first packet associated with a first workload, the third packets associated with respective second workloads.

Example 38 includes the non-transitory machine-readable storage medium of example 37, wherein the delay is a first delay, the bitrate is a first bitrate, the delay threshold is a first delay threshold, and the instructions cause the programmable circuitry to, based on the first bitrate not satisfying the average, set a second bitrate to be utilized to transmit the second packet based on whether a difference between the first delay and a second delay satisfies a second delay threshold.

Example 39 includes the non-transitory machine-readable storage medium of any of examples 34, 35, 36, 37, or 38, wherein the packet is a first packet, the interface circuitry is associated with a queue, and the instructions cause the programmable circuitry to set a bitrate to be utilized to transmit a second packet including the result based on a delay associated with the processing of the payload at the in-network device and a utilization of the queue.

Example 40 includes the non-transitory machine-readable storage medium of any of examples 34, 35, 36, 37, 38, or 39, wherein the payload is a first payload, the packet is a first packet, and the instructions cause the programmable circuitry to decrease a bitrate to be utilized by the in-network device to transmit a third packet based on a first delay associated with the processing of the first payload at the in-network device being greater than a second delay associated with processing of a second payload at the in-network device, the first packet and the third packet associated with a same workload type.

Example 41 includes the non-transitory machine-readable storage medium of any of examples 34, 35, 36, 37, 38, 39, or 40, wherein the packet is a first packet, and the instructions cause the programmable circuitry to cause the interface circuitry to transmit a second packet to identify (a) a bitrate to be utilized to transmit a third packet including the result and (b) at least one of a delay associated with the processing of the payload at the in-network device, a utilization of a queue of the interface circuitry, the utilization associated with the third packet, a first identifier of a third device from which the first packet originated, or a second identifier of a fourth device at which the third packet is to terminate.

Example 42 includes the non-transitory machine-readable storage medium of any of examples 34, 35, 36, 37, 38, 39, 40, or 41, wherein the header field is a first header field, and the packet includes second header fields, the second header fields related to a protocol for communication of the packet.

Example 43 includes the non-transitory machine-readable storage medium of any of examples 34, 35, 36, 37, 38, 39, 40, 41, or 42, wherein the payload includes first payload data, and the instructions cause the programmable circuitry to process the first payload data to generate second payload data, the second payload data corresponding to the result of processing the payload, and replace the first payload data of the payload with the second payload data.

Example 44 includes the non-transitory machine-readable storage medium of any of examples 34, 35, 36, 37, 38, 39, 40, 41, 42, or 43, wherein the header field identifies a workload type associated with the payload, and the instructions cause the programmable circuitry to trigger a protocol corresponding to the workload type.

Example 45 includes the non-transitory machine-readable storage medium of any of examples 34, 35, 36, 37, 38, 39, 40, 41, 42, 43, or 44, wherein the header field identifies a workload type associated with the payload, and the workload type corresponds to at least one of a compression workload, an encryption workload, a scatter/gather workload, a load balancing workload, a network address translation workload, a domain name system server workload, a caching workload, a data reduction workload, or a data aggregation workload.

Example 46 includes a method comprising parsing, by utilizing an instruction with programmable circuitry of an in-network device, to identify a header field of a packet, the packet from a first device in a network, processing, with the programmable circuitry, a payload included with the packet at the in-network device based on the header field, and transmitting, with interface circuitry of the in-network device, a result of processing the payload to at least one of the first device or a second device.

Example 47 includes the method of example 46, wherein the packet is a first packet, and the method further includes determining a bitrate to be utilized to transmit a second packet including the result, the bitrate based on a delay associated with the processing of the payload at the in-network device, and transmitting a third packet to identify the bitrate to at least one of the first device or the second device.

Example 48 includes the method of any of examples 46 and 47, further including determining whether a delay associated with the processing of the payload at the in-network device satisfies a delay threshold.

Example 49 includes the method of example 48, wherein the packet is a first packet, and the method further includes, based on the delay satisfying the delay threshold, determining whether a bitrate currently utilized to transmit a second packet including the result satisfies an average of an upper bitrate threshold for the in-network device and a number of third packets to be transmitted by the in-network device, the first packet associated with a first workload, the third packets associated with respective second workloads.

Example 50 includes the method of example 49, wherein the delay is a first delay, the bitrate is a first bitrate, the delay threshold is a first delay threshold, and the method further includes, based on the first bitrate not satisfying the average, setting a second bitrate to be utilized to transmit the second packet based on whether a difference between the first delay and a second delay satisfies a second delay threshold.

Example 51 includes the method of any of examples 46, 47, 48, 49, or 50, wherein the packet is a first packet, the interface circuitry is associated with a queue, and the method further includes setting a bitrate to be utilized to transmit a second packet including the result based on a delay associated with the processing of the payload at the in-network device and a utilization of the queue.

Example 52 includes the method of any of examples 46, 47, 48, 49, 50, or 51, wherein the payload is a first payload, the packet is a first packet, and the method further includes decreasing a bitrate to be utilized by the in-network device to transmit a third packet based on a delay associated with the processing of the first payload at the in-network device being greater than a second delay associated with processing of a second payload at the in-network device, the first packet and the third packet associated with a same workload type.

Example 53 includes the method of any of examples 46, 47, 48, 49, 50, 51, or 52, wherein the packet is a first packet, and the method further includes transmitting a second packet to identify (a) a bitrate be utilized to transmit a third packet including the result and (b) at least one of a delay associated with the processing of the payload at the in-network device, a utilization of a queue of the interface circuitry, the utilization associated with the third packet, a first identifier of a third device from which the first packet originated, or a second identifier of a fourth device at which the third packet is to terminate.

Example 54 includes the method of any of examples 46, 47, 48, 49, 50, 51, 52, or 53, wherein the header field is a first header field, and the packet includes second header fields, the second header fields related to a protocol for communication of the packet.

Example 55 includes the method of any of examples 46, 47, 48, 49, 50, 51, 52, 53, or 54, wherein the payload includes first payload data, and the processing the first payload data to generate second payload data, the second payload data corresponding to the result of processing the payload, and the transmitting (i) replacing the first payload data of the payload with the second payload data to update the packet, and (ii) transmitting the updated packet to the second device.

Example 56 includes the method of any of examples 46, 47, 48, 49, 50, 51, 52, 53, 54, or 55, wherein the header field identifies a workload type associated with the payload, and the method further includes triggering a protocol corresponding to the workload type.

Example 57 includes the method of any of examples 46, 47, 48, 49, 50, 51, 52, 53, 54, 55, or 56, wherein the header field identifies a workload type associated with the payload, and the workload type corresponds to at least one of a compression workload, an encryption workload, a scatter/gather workload, a load balancing workload, a network address translation workload, a domain name system server workload, a caching workload, a data reduction workload, or a data aggregation workload.

Example 58 includes a first device comprising machine-readable instructions, programmable circuitry to utilize the machine-readable instructions to generate a packet including a payload and a header field, the header field to identify a workload type associated with the packet, and interface circuitry to transmit the packet to an in-network device.

Example 59 includes the first device of example 58, wherein the packet is a first packet, the interface circuitry is associated with a queue, and the programmable circuitry is to cause the interface circuitry to transmit the first packet to the in-network device at a bitrate based on a predicted delay and whether a utilization of the queue satisfies a threshold, the predicted delay based on a delay measurement of a second packet.

Example 60 includes the first device of example 59, wherein the threshold is a first threshold, and the programmable circuitry is to determine whether the predicted delay satisfies a second threshold.

Example 61 includes the first device of any of examples 58, 59, or 60, wherein the packet is a first packet, the header field is a first header field, the interface circuitry is associated with a queue, and the programmable circuitry is to set a flag in a second header field of the first packet based on a utilization of the queue satisfying a first threshold and a predicted delay satisfying a second threshold, the predicted delay based on a delay measurement of a second packet.

Example 62 includes the first device of any of examples 58, 59, 60, or 61, wherein the programmable circuitry is to include an identifier of the workload type in the header field of the packet.

Example 63 includes the first device of any of examples 58, 59, 60, 61, or 62, wherein the packet is a first packet, the header field is a first header field, the interface circuitry is associated with a queue, and the programmable circuitry is to identify a second packet based on a second header field included with the second packet, the second header field associated with the workload type, and predict a first utilization of the queue based on a second utilization of the queue during transmission of the second packet.

Example 64 includes the first device of any of examples 58, 59, 60, 61, 62, or 63, wherein the programmable circuitry is to determine an operation according to which a command is to be processed, the command generated based on a workload corresponding to the workload type, and convert the command into the packet based on the operation and a priority of the workload type.

Example 65 includes the first device of any of examples 58, 59, 60, 61, 62, 63, or 64, wherein the header field is a first header field, and the packet includes second header fields, the second header fields related to a protocol for communication of the packet.

Example 66 includes the first device of any of examples 58, 59, 60, 61, 62, 63, 64, or 65, wherein the header field is to trigger a protocol at the in-network device, the protocol corresponding to the workload type.

Example 67 includes the first device of any of examples 58, 59, 60, 61, 62, 63, 64, 65, or 66, wherein the workload type corresponds to at least one of a compression workload, an encryption workload, a scatter/gather workload, a load balancing workload, a network address translation workload, a domain name system server workload, a caching workload, a data reduction workload, or a data aggregation workload.

Example 68 includes a non-transitory machine-readable storage medium comprising instructions to cause programmable circuitry to at least generate a packet including a payload and a header field, the header field to identify a workload type associated with the packet, and cause interface circuitry to transmit the packet to an in-network device.

Example 69 includes the non-transitory machine-readable storage medium of example 68, wherein the packet is a first packet, the interface circuitry is associated with a queue, and the instructions cause the programmable circuitry to cause the interface circuitry to transmit the first packet to the in-network device at a bitrate based on a predicted delay and whether a utilization of the queue satisfies a threshold, the predicted delay based on a delay measurement of a second packet.

Example 70 includes the non-transitory machine-readable storage medium of example 69, wherein the threshold is a first threshold, and the instructions cause the programmable circuitry to determine whether the predicted delay satisfies a second threshold.

Example 71 includes the non-transitory machine-readable storage medium of any of examples 68, 69, or 70, wherein the packet is a first packet, the header field is a first header field, the interface circuitry is associated with a queue, and the instructions cause the programmable circuitry to set a flag in a second header field of the first packet based on a utilization of the queue satisfying a first threshold and a predicted delay satisfying a second threshold, the predicted delay based on a delay measurement of a second packet.

Example 72 includes the non-transitory machine-readable storage medium of any of examples 68, 69, 70, or 71, wherein the instructions cause the programmable circuitry to include an identifier of the workload type in the header field of the packet.

Example 73 includes the non-transitory machine-readable storage medium of any of examples 68, 69, 70, 71, or 72, wherein the packet is a first packet, the header field is a first header field, the interface circuitry is associated with a queue, and the instructions cause the programmable circuitry to identify a second packet based on a second header field included with the second packet, the second header field associated with the workload type, and predict a first utilization of the queue based on a second utilization of the queue during transmission of the second packet.

Example 74 includes the non-transitory machine-readable storage medium of any of examples 68, 69, 70, 71, 72, or 73, wherein the instructions cause the programmable circuitry to determine an operation according to which a command is to be processed, the command generated based on a workload corresponding to the workload type, and convert the command into the packet based on the operation and a priority of the workload type.

Example 75 includes the non-transitory machine-readable storage medium of any of examples 68, 69, 70, 71, 72, 73, or 74, wherein the header field is a first header field, and the packet includes second header fields, the second header fields related to a protocol for communication of the packet.

Example 76 includes the non-transitory machine-readable storage medium of any of examples 68, 69, 70, 71, 72, 73, 74, or 75, wherein the header field is to trigger a protocol at the in-network device, the protocol corresponding to the workload type.

Example 77 includes the non-transitory machine-readable storage medium of any of examples 68, 69, 70, 71, 72, 73, 74, 75, or 76, the workload type corresponds to at least one of a compression workload, an encryption workload, a scatter/gather workload, a load balancing workload, a network address translation workload, a domain name system server workload, a caching workload, a data reduction workload, or a data aggregation workload.

Example 78 includes a method comprising generating, by utilizing an instruction with programmable circuitry, a packet including a payload and a header field, the header field to identify a workload type associated with the packet, and transmitting, with interface circuitry, the packet to an in-network device.

Example 79 includes the method of example 78, the packet is a first packet, the interface circuitry is associated with a queue, and the method further includes transmitting the first packet to the in-network device at a bitrate based on a predicted delay and whether a utilization of the queue satisfies a threshold, the predicted delay based on a delay measurement of a second packet.

Example 80 includes the method of example 79, wherein the threshold is a first threshold, and the method further includes determining whether the predicted delay satisfies a second threshold.

Example 81 includes the method of any of examples 78, 79, or 80, the packet is a first packet, the header field is a first header field, the interface circuitry is associated with a queue, and the method further includes setting a flag in a second header field of the first packet based on a utilization of the queue satisfying a first threshold and a predicted delay satisfying a second threshold, the predicted delay based on a delay measurement of a second packet.

Example 82 includes the method of any of examples 78, 79, 80, or 81, further including inserting an identifier of the workload type in the header field of the packet.

Example 83 includes the method of any of examples 78, 79, 80, 81, or 82, wherein the packet is a first packet, the header field is a first header field, the interface circuitry is associated with a queue, and the method further includes identifying a second packet based on a second header field included with the second packet, the second header field associated with the workload type, and predicting a first utilization of the queue based on a second utilization of the queue during transmission of the second packet.

Example 84 includes the method of any of examples 78, 79, 80, 81, 82, or 83, further including determining an operation according to which a command is to be processed, the command generated based on a workload corresponding to the workload type, and converting the command into the packet based on the operation and a priority of the workload type.

Example 85 includes the method of any of examples 78, 79, 80, 81, 82, 83, or 84, wherein the header field is a first header field, and the packet includes second header fields, the second header fields related to a protocol for communication of the packet.

Example 86 includes the method of any of examples 78, 79, 80, 81, 82, 83, 84, or 85, wherein the header field is to trigger a protocol at the in-network device, the protocol corresponding to the workload type.

Example 87 includes the method of any of examples 78, 79, 80, 81, 82, 83, 84, 85, or 86, the workload type corresponds to at least one of a compression workload, an encryption workload, a scatter/gather workload, a load balancing workload, a network address translation workload, a domain name system server workload, a caching workload, a data reduction workload, or a data aggregation workload.

Example 88 includes an in-network device comprising interface circuitry to obtain a packet transmitted from a source to a destination in a network, machine-readable instructions, and programmable circuitry to utilize the machine-readable instructions to access a payload of the packet, the payload associated with a workload class identified by a header field of the packet, perform an action associated with the workload class on first payload data of the packet to generate second payload data, and cause the interface circuitry to forward the packet including an updated payload toward the destination, the updated payload based on the second payload data.

Example 89 includes the in-network device of example 88, wherein the header field is a first header field, and the packet includes second header fields, the second header fields related to a protocol for communication of the packet.

Example 90 includes the in-network device of any of examples 88 or 89, wherein the second payload data includes a result of the action, and the programmable circuitry is to replace the first payload data with the second payload data to generate the updated payload.

Example 91 includes the in-network device of any of examples 88, 89, or 90, wherein the programmable circuitry is to trigger a protocol corresponding to the workload class.

Example 92 includes the in-network device of any of examples 88, 89, 90, or 91, wherein the workload class corresponds to at least one of a compression workload, an encryption workload, a scatter/gather workload, a load balancing workload, a network address translation workload, a domain name system server workload, a caching workload, a data reduction workload, or a data aggregation workload.

Example 93 includes the in-network device of any of examples 88, 89, 90, 91, or 92, wherein the packet is a first packet, the programmable circuitry is to determine a bitrate to be utilized to transmit the first packet including the updated payload, the bitrate based on a delay associated with processing of the first payload data at the in-network device, and the interface circuitry is to transmit a second packet toward the source, the second packet to identify the bitrate.

Example 94 includes the in-network device of any of examples 88, 89, 90, 91, 92, or 93, wherein the interface circuitry is associated with a queue, and the programmable circuitry is to set a bitrate to be utilized to transmit the packet including the updated payload based on a delay associated with processing of the first payload data at the in-network device and a utilization of the queue.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A device to be deployed in a network, the device comprising:
interface circuitry to access a packet including a header having (1) a destination address field to identify a first network address of a destination device capable of performing an action and (2) a workload class field to identify a workload class associated with the action;
machine-readable instructions;
programmable circuitry to utilize the machine-readable instructions to:
perform the action at the device based on the workload class field, the device having a second network address that is different than the first network address;
modify an indicator field of the packet to indicate that the action has been performed; and
cause the interface circuitry to forward the packet with the modified indicator field toward the destination device.

2. The device of claim 1, wherein the action includes an in-network compute primitive, the in-network compute primitive including at least one of a vector summation operation, a count operation, a cache operation, a store operation, a get operation, or a hash table operation.

3. The device of claim 1, wherein the packet is a first packet, and the programmable circuitry is to cause the interface circuitry to transmit a second packet toward a source device of the packet, the second packet to identify at least one in-network compute primitive ability of the programmable circuitry.

4. The device of claim 1, wherein the packet is to be transmitted along a communication path from a source device to the destination device, and the programmable circuitry is to:
determine a level of congestion at another network device in the communication path; and
determine to perform the action at the device based on the level of congestion.

5. The device of claim 4, wherein the programmable circuitry is to determine the level of congestion based on at least one of a congestion notification field, a delay level field, a queue state field, or a fair rate field, in the header of the packet.

6. The device of claim 4, wherein the programmable circuitry is to perform the action at the device during a delay introduced by the level of congestion.

7. The device of claim 1, wherein the packet is a first packet, the action is a first action, and the first packet is to be transmitted along a communication path from a source device to the destination device, and the programmable circuitry is to:
determine a level of congestion at a subsequent device in the communication path based on a feedback packet from the subsequent device, the feedback packet including at least one of a bitrate to be utilized by the subsequent device to transmit a second packet, a utilization of a queue at the subsequent device by the second packet, or a processing delay associated with performing a second action associated with the second packet at the subsequent device instead of the destination device; and
determine to perform the action at the device based on the level of congestion at the subsequent device.

8. The device of claim 7, wherein the programmable circuitry is to perform the action at the device during a delay introduced by the level of congestion at the subsequent device.

9. The device of claim 1, wherein the action is to be performed based on a payload of the packet, the payload is associated with an application, and the programmable circuitry is to modify the payload before the packet is forwarded toward the destination device.

10. The device of claim 1, wherein:
the packet is a first packet;
the programmable circuitry is to determine a bitrate to be utilized to transmit the first packet towards the destination device, the bitrate based on a delay associated with performance of the action at the device; and
the interface circuitry is to transmit a second packet to identify the bitrate toward at least one of a source device of the packet or the destination device.

11. A source device comprising:
machine-readable instructions;
programmable circuitry to utilize the machine-readable instructions to generate a packet including a header having (1) a destination address field to identify a network address of a destination device, and (2) a workload class field to identify a workload class associated with an action capable of being performed by the destination device, the workload class to be accessed by an intervening device along a communication path between the source device and the destination device, the intervening device to perform the action instead of the destination device; and
interface circuitry to transmit the packet to the intervening device.

12. The source device of claim 11, wherein the packet is a first packet, and the programmable circuitry is to:
based on a second packet from the intervening device, determine at least one in-network compute primitive that can be performed by the intervening device; and
select the communication path of the packet based on the at least one in-network compute primitive and the workload class.

13. The source device of claim 12, wherein the at least one in-network compute primitive is identified in the second packet.

14. The source device of claim 12, wherein the at least one in-network compute primitive includes at least one of a vector summation operation, a count operation, a cache operation, a store operation, a get operation, or a hash table operation.

15. The source device of claim 11, wherein the programmable circuitry is to populate at least one of a congestion notification field, a delay level field, a queue state field, or a fair rate field in the header of the packet before the packet is transmitted to the intervening device.

16. The source device of claim 11, wherein the packet is a first packet, the action is a first action, and the programmable circuitry is to:
access a feedback packet from the intervening device, the feedback packet including at least one of a first bitrate to be utilized by the intervening device to transmit a second packet, a utilization of a queue at the intervening device by the second packet, or a processing delay associated with performing a second action associated with the second packet at the intervening device instead of the destination device; and
cause the interface circuitry to transmit the first packet to the intervening device at a second bitrate based on the feedback packet.

17. The source device of claim 11, wherein the packet is a first packet, the interface circuitry is associated with a queue, and the programmable circuitry is to cause the interface circuitry to transmit the first packet to the intervening device at a bitrate based on a predicted delay and a utilization of the queue, the predicted delay based on a delay measurement of a second packet.

18. The source device of claim 11, wherein the header includes the workload class field and one or more second fields different than the workload class field, the one or more second fields including one or more of a version field, an internet header length field, a packet length field, a packet identifier field, a packet fragmentation flag field, a packet fragmentation offset field, a time to live field, a header checksum field, a source address field, the destination address field, a time stamp field, a retransmission field, or an acknowledgement field.

19. A device to be deployed in a network, the device comprising:
machine-readable instructions;
programmable circuitry to utilize the machine-readable instructions to:
parse a first packet from a source device, the first packet addressed to a destination device in the network, the first packet including a payload and a header, the header including a workload class field and one or more second fields different than the workload class field, the workload class field to indicate a workload class to be used to process the payload of the first packet, the one or more second fields including one or more of a version field, an internet header length field, a packet length field, a packet identifier field, a packet fragmentation flag field, a packet fragmentation offset field, a time to live field, a header checksum field, a source address field, a destination address field, a time stamp field, a retransmission field, or an acknowledgement field;
prior to the first packet reaching the destination device, perform an operation on the payload that is not associated with routing of the first packet, the operation to produce an output; and
interface circuitry to forward a second packet corresponding to the output to the destination device.

20. The device of claim 19, wherein:
the programmable circuitry is to determine a bitrate to be utilized to transmit the first packet towards the destination device, the bitrate based on a delay associated with performance of the operation at the device; and
the interface circuitry is to transmit a third packet to identify the bitrate toward at least one of the source device of the first packet or the destination device.
